(19) United States
(12) Patent Application Publication
(10) Pub. No.: US 2010/0264378 A1
(43) Pub. Date: Oct. 21, 2010

(54) PHOTOSENSITIVE COMPOSITION, TRANSPARENT CONDUCTIVE FILM, DISPLAY ELEMENT AND INTEGRATED SOLAR BATTERY

(75) Inventors: Kenji Naoi, Ashigarakami-gun (JP); Yoichi Hosoya, Ashigarakami-gun (JP); Nori Miyagishima, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/762,057

(22) Filed: Apr. 16, 2010

(30) Foreign Application Priority Data
Apr. 16, 2009 (JP) 2009-100093

(51) Int. Cl. H01B 1/22

(52) U.S. Cl. 252/514; 977/762

(57) ABSTRACT

A photosensitive composition including a random copolymer formed through copolymerization of at least one compound represented by the following General Formula (1) and another monomer having an unsaturated bond, a photosensitive compound, and a nanowire structure:

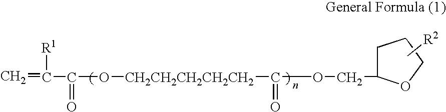

where R¹ represents a hydrogen atom or a methyl group, R² represents a C1 to C5 alkyl group and n is an integer of 0 to 5.

### BACKGROUND OF THE INVENTION

1. Field of the Invention

The present invention relates to a photosensitive composition used for producing, for example, a liquid crystal display element, an EL display element and an integrated solar battery; to a transparent conductive film using the photosensitive composition; to a display element; and to an integrated solar battery.

2. Description of the Related Art

A patterned transparent film is used in many parts of a display element such as a spacer, an insulative film and a protective film, and hitherto, many photosensitive compositions (hereinafter may be referred to as a “resist”) have been proposed for forming the transparent film (see Japanese Patent Application Laid-Open (JP-A) Nos. 04-164902 and 07-140654).

In general, thin film transistor liquid crystal displays, an integrated solar batteries, etc. include an insulative film for insulating wirings planarily disposed in the form of laminate, the insulative film having a pattern formed through mechanical scribing or laser scribing. Widely used materials for forming the insulative film are photosensitive compositions which require a small number of steps for obtaining a desirably patterned insulative film. The photosensitive composition is desired to have a wide process margin in the process of forming an insulative film.

Further, the produced insulative film or display element using a photosensitive composition must be exposed, for example, to a solvent, an acid and an alkaline solution through immersion, and be thermally treated. With the recent developments of semiconductor technology, a photosensitive composition is required to meet stricter requirements year by year, and various attempts have been made to develop satisfactory compositions. But, no material has been reported which has high solvent resistance, high waterproofness, high acid resistance, high alkali resistance, high heat resistance, high transparency, excellent adhesion to a base, etc., and keen demand has arisen for a material that have all of these properties.

Meanwhile, wirings are generally formed in light-transmissive portions as follows, considering required properties such as conductivity, transparency and patterning property. Specifically, indium tin oxide (hereinafter may be referred to as “ITO”) and zinc oxide are applied through a dry process such as vapor-deposition or sputtering, and then a negative-type resist is used to form a transparent conductive pattern. But, the above production method requires a lot of steps for forming a patterned transparent conductive pattern, such as application of a negative-type resist, development thereof and etching of the conductive material; and also requires large facilities requiring vacuum conditions and a multi-step chemical treatment. Thus, the simplification of the process is desired in terms of not only improvement in performance of the final product but also the recent concerns about the environment and energy issues.

At present, in terms of process cost, environment and energy issues, there is a need to rapidly provide, for example, a photosensitive composition with which a patterned transparent conductive film can be formed through a simple process and which has high solvent resistance, high waterproofness, high alkali resistance, high heat resistance, high transparency, excellent adhesion to a base, high conductivity, etc.; a transparent conductive film which is formed from the photosensitive composition and which has high solvent resistance, high waterproofness, high alkali resistance, high heat resistance, high transparency, excellent adhesion to a base, etc.; and a display element and an integrated solar battery using the transparent conductive film.

### BRIEF SUMMARY OF THE INVENTION

The present invention aims to provide a photosensitive composition with which a patterned transparent conductive film can be formed through a simple process and which has high solvent resistance, high waterproofness, high alkali resistance, high heat resistance, high transparency, excellent adhesion to a base, high conductivity, etc.; a transparent conductive film which is formed from the photosensitive composition and which has high solvent resistance, high waterproofness, high alkali resistance, high heat resistance, high transparency, excellent adhesion to a base, etc.; and a display element and an integrated solar battery using the transparent conductive film.

Means for solving the above problems are as follows.

<1> A photosensitive composition including:

a random copolymer formed through copolymerization of at least one compound represented by the following General Formula (1) and another monomer having an unsaturated bond,

a photosensitive compound, and

a nanowire structure:

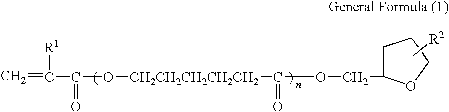

where R¹ represents a hydrogen atom or a methyl group, R² represents a C1 to C5 alkyl group and n is an integer of 0 to 5.

<2> The photosensitive composition according to <1> above, wherein the amount of the at least one compound represented by General Formula (1) contained in the random copolymer is 1 mol % to 80 mol %.

<3> The photosensitive composition according to one of <1> and <2> above, wherein the another monomer is at least one of a compound represented by the following General Formula (2), a compound represented by the following General Formula (3) and a compound represented by the following General Formula (4), and wherein, in the random copolymer, the amount of the at least one compound represented by General Formula (1) is 1 mol % to 50 mol %, the amount of the compound represented by General Formula (2) is 20 mol % to 70 mol %, the amount of the compound represented by General Formula (3) is 0 mol % to 30 mol % and the amount of the compound represented by General Formula (4) is 5 mol % to 40 mol %:

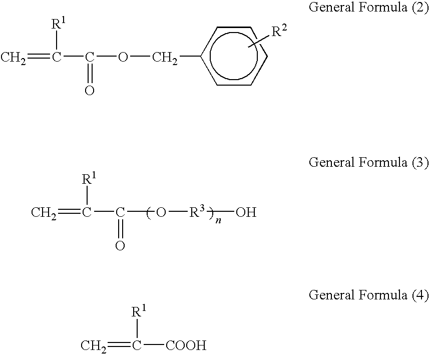

in General Formulas (2), (3) and (4), R¹ represents a hydrogen atom or a methyl group, R² represents a C1 to C5 alkyl group, R³ represents a C1 to C8 alkylene group and n is an integer of 1 to 5.

<4> The photosensitive composition according to any one of <1> to <3> above, wherein the random copolymer has a weight average molecular weight converted to polyethylene oxide of 2,000 to 30,000, which is measured by gel permeation chromatography (GPC) using N,N-dimethylformamide (DMF) as a solvent.

<5> The photosensitive composition according to any one of <1> to <4> above, wherein the nanowire structure is a metal nanowire.

<6> The photosensitive composition according to <5> above, wherein the metal nanowire has a minor axis length of 50 nm or less and a major axis length of 5 μm or greater, and is contained in an amount of 50% by mass or more in terms of metal amount with respect to total metal particles.

<7> A transparent conductive film including:

the photosensitive composition according to any one of <1> to <6> above.

<8> A display element including:

the transparent conductive film according to <7> above.

<9> An integrated solar battery including:

the transparent conductive film according to <7> above.

The present invention can provide a photosensitive composition with which a patterned transparent conductive film can be formed through a simple process and which has high solvent resistance, high waterproofness, high alkali resistance, high heat resistance, high transparency, excellent adhesion to a base, high conductivity, etc.; a transparent conductive film which is formed from the photosensitive composition and which has high solvent resistance, high waterproofness, high alkali resistance, high heat resistance, high transparency, excellent adhesion to a base, etc.; and a display element and an integrated solar battery using the transparent conductive film. These can solve the existing problems pertinent in the art.

### BRIEF DESCRIPTION OF THE DRAWINGS

FIG. 1 is an explanatory diagram illustrating a method for obtaining a sharpness of a metal nanowire.

FIG. 2A illustrates a step of an exemplary method for producing a cell of a CIGS thin film solar battery.

FIG. 2B illustrates a step of an exemplary method for producing a cell of a CIGS thin film solar battery.

FIG. 2C illustrates a step of an exemplary method for producing a cell of a CIGS thin film solar battery.

FIG. 2D illustrates a step of an exemplary method for producing a cell of a CIGS thin film solar battery.

FIG. 3 is a diagram of the relationship between a lattice constant and band gap in the semiconductor formed of the Ib group element, Mb group element, and VIb group element.

### DETAILED DESCRIPTION OF THE INVENTION

Next will be described in detail a photosensitive composition of the present invention. The constituent members of the positive-type photosensitive composition are described based on typical embodiments, which should not be construed as limiting the present invention thereto.

Notably, in the range “the lower value to the upper value” in the present specification, the range includes these lower and upper values; i.e., “the lower value inclusive to the upper value inclusive.”

As used herein, the term “light” is used as a term encompassing visible lights, ultraviolet rays, X-rays and electron beams.

Also, in the present specification, acrylic acid and methacrylic acid may be collectively expressed as “(meth)acrylic acid.” Similarly, acrylate and methacrylate may be collectively expressed as “(meth)acrylate.”

### (Photosensitive Composition)

A photosensitive composition of the present invention contains a random copolymer formed through copolymerization of at least one compound represented by the following General Formula (1) and another monomer having an unsaturated bond, a photosensitive compound, and a nanowire structure; and, if necessary, further contains other components:

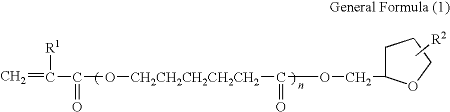

where R¹ represents a hydrogen atom or a methyl group, R² represents a C1 to C5 alkyl group, and n is an integer of 0 to 5.

In General Formula (1), the C1 to C5 alkyl group represented by R² is linear or branched alkyl groups, and examples thereof include methyl, ethyl, proply, n-butyl, t-butyl and pentyl.

### <Random Copolymer>

The random copolymer is formed through copolymerization of at least one compound represented by the above General Formula (1) and another monomer having an unsaturated bond.

Specifically, the random copolymer can be obtained as follows. First, ε-caprolactone is added to the hydroxyl group of tetrahydrofurfuryl alcohol or a substituted tetrahydrofurfuryl alcohol, and the resultant addition product was esterified through dehydration with acrylic acid or methacrylic acid, to thereby produce an acrylic compound used as a monomer. Then, the thus-produced monomer was randomly copolymerized with the below-described another monomer.

—Compound represented by General Formula (1)—

Compounds represented by General Formula (1) where n=1 are preferred since they have high effects of forming an appropriately patterned edge shape. Examples of employable compounds represented by General Formula (1) where n=1 include commercially available KAYARAD TC-110S (product of NIPPON KAYAKU Co., Ltd.).

—Another Monomer having Unsaturated Bond—

Examples of the another monomer having an unsaturated bond include (meth)acrylic acid, 2-hydroxyethyl (meth)acrylate, 2-hydroxypropyl (meth)acrylate, 4-hydroxybutyl (meth)acrylate, methyl (meth)acrylate, ethyl (meth)acrylate, isopropyl (meth)acrylate, n-butyl (meth)acrylate, isobutyl (meth)acrylate, t-butyl (meth)acrylate, 2-ethylhexyl (meth)acrylate, hexyl (meth)acrylate, cyclohexyl (meth)acrylate, octyl (meth)acrylate, tridecyl (meth)acrylate, lauryl (meth)acrylate, stearyl (meth)acrylate, phenyl (meth)acrylate, benzyl (meth)acrylate, 2-methoxyethyl (meth)acrylate, ethoxyethoxyethyl (meth)acrylate, 3-methoxybutyl (meth)acrylate, phenoxyethyl (meth)acrylate, cetyl (meth)acrylate, isobornyl (meth)acrylate, dimethylaminoethyl (meth)acrylate, dimethylaminoethyl (meth)acrylate quaternary compounds, morpholinoethyl (meth)acrylate and trimethylsiloxyethyl (meth)acrylate.

Further examples include (meth)acrylic acid esters such as VISCOAT #193, VISCOAT #320, VISCOAT#2311HP, VISCOAT#220, VISCOAT #2000, VISCOAT #2100, VISCOAT #2150, VISCOAT #2180, VISCOAT 3F, VISCOAT 3FM, VISCOAT 4F, VISCOAT 4FM, VISCOAT 6FM, VISCOAT 8F, VISCOAT 8FM, VISCOAT 17F, VISCOAT 17FM, VISCOAT MTG (these products are of OSAKA ORGANIC CHEMICAL INDUSTRY LTD.) M-101, M-102, M-110, M-113, M-117, M-120, M-5300, M-5600, M-5700, TO-850, TO-851, TO-1248, TO-1249, TO-1301, TO-1317, TO-1315, TO-981, TO-1215, TO-1316, TO-1322, TO-1342, TO-1340 and TO-1225 (these products are of TOAGOSEI CO., LTD.); (meth)acrylamides such as cyclohexene-3,4-dicarboxylic acid-(2-monomethacryloxy)ethyl, 3-cyclohexenylmethyl methacrylate, 2-tetrahydrophthalimideethyl methacrylate, (meth)acrylamide, dimethylaminopropyl (meth)acrylamide and N,N-dimethylacrylamide; styrene, α-methylstyrene, maleic anhydride, N-vinylpyrrolidone and 4-acryloylmorpholine.

Among them, particularly preferred are (meth)acrylic acid, 2-hydroxyethyl (meth)acrylate, 2-hydroxypropyl (meth)acrylate, benzyl (meth)acrylate, cyclohexyl (meth)acrylate and 3-cyclohexenylmethyl methacrylate.

Preferred examples of the another monomer having an unsaturated bond include compounds represented by the following General Formulas (2), (3) and (4):

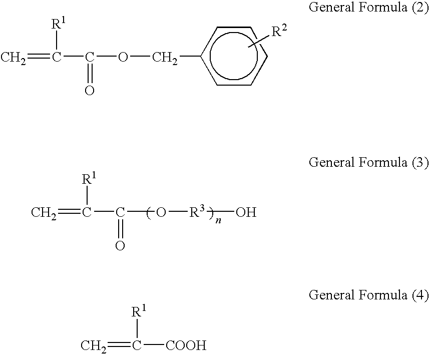

in General Formulas (2), (3) and (4), R¹ represents a hydrogen atom or a methyl group, R² represents a C1 to C5 alkyl group, R³ represents a C1 to C8 alkylene group, and n is an integer of 1 to 5.

In General Formulas (2), (3) and (4), the C1 to C5 alkyl group represented by R² is linear or branched alkyl groups, and examples thereof include methyl, ethyl, propyl, n-butyl, t-butyl and pentyl.

In General Formula (2), (3) and (4), examples of the C1 to C8 alkylene group represented by R³ include methylene, ethylene, propylene and butylene.

The random copolymer is preferably copolymers in which the amount of the compound represented by General Formula (1) is 1 mol % to 50 mol %, the amount of the monomer represented by General Formula (2) is 20 mol % to 70 mol %, the amount of the monomer represented by General Formula (3) is 0 mol % to 30 mol %, and the amount of the monomer represented by General Formula (4) is 5 mol % to 40 mol %.

The polymerizing method employed is preferably radical polymerization in a solution; i.e., random copolymerization using a radical catalyst. The radical copolymerization is easier to industrially perform than block copolymerization and graft copolymerization and also, there is no need to perform such block and graft copolymerizations. Furthermore, the random copolymer is excellent in compatibility to other resins and dissolvability to solvents, and thus, is preferred for achieving the objects of the present invention.

The solvent used for polymerization is not particularly limited, so long as it can dissolve the formed polymer, and may be appropriately selected depending on the purpose. Examples thereof include methanol, ethanol, 2-propanol, acetone, 2-butanone, ethyl acetate, butyl acetate, ethylene glycol monoisopropyl ether, ethylene glycol monobutyl ether, ethyl carbitol, propylene glycol monomethyl ether, propylene glycol monomethyl ether acetate, ethylene glycol monobutyl ether acetate, cyclohexanone, diethylene glycol dimethyl ether, diethylene glycol diethyl ether, toluene, xylene, γ-butyrolactone and N,N-dimethylacetamide. These may be used individually or in combination. Among them, particularly preferred are methanol, ethyl acetate, cyclohexanone and propylene glycol monomethyl ether.

The polymerization is generally performed under the following conditions: the concentration of monomer: 5% by mass to 50% by mass, the concentration of radical generator: 0.01% by mass to 5% by mass, the reaction temperature: 50° C. to 160° C., and the reaction time: 3 hours to 12 hours. To adjust the molecular weight of the formed polymer, a chain transfer agent such as thioglycolic acid may be added to the reaction system. The liquid obtained after completion of reaction may be directly used as a photosensitive resin composition. Alternatively, the liquid is added to a large amount of a non-solvent, and then the formed precipitates are dried to remove oligomers and unreacted monomers. When the liquid obtained after the polymerization is added to a large amount of a non-solvent for purification of the formed polymer, preferably, in terms of drying properties, the polymerization is performed in a mixture of methanol and ethyl acetate, and the resultant liquid is added to a non-solvent such as cyclohexane or an ethyl acetate-cyclohexane mixture.

The amount of the compound represented by General Formula (1) contained in the formed random copolymer is preferably 1 mol % to 80 mol %, more preferably 1 mol % to 40 mol %, still more preferably 3 mol % to 20 mol %. When the amount is less than 1 mol %, disadvantageous peeling off tends to occur during development. Whereas when the amount is more than 80 mol %, scums may be easily formed.

The average molecular weight of the random copolymer is not particularly limited and may be appropriately determined depending on the purpose. Preferably, the random copolymer has a weight average molecular weight (converted to polyethylene oxide) of 2,000 to 30,000, which is measured by gel permeation chromatography (GPC) using N,N-dimethylformamide (DMF) as a solvent. When the weight average molecular weight is lower than 2,000, the formed film decreases in strength and is roughed during development, potentially causing the pattern to be easily peeled off. When the weight average molecular weight is higher than 30,000, scums tend to occur and pattern edges have a jagged shape, which is problematic.

### <Photosensitive Compound>

Examples of the photosensitive compound include (1) photoradical generators which generate radicals through irradiation of light, (2) sensitizers which promote radical generation, (3) polymerizable monomers which react with radicals generated, and (4) azide compounds which form nitrene through irradiation of light. Notably, photoradical generators and sensitizers do not directly react with the random copolymer and thus, must be used in combination with polymerizable monomers.

### —Photoradical Generator and Sensitizer—

The photoradical generator and sensitizer are not particularly limited and may be appropriately selected depending on the purpose. Examples thereof include benzophenone, Michler's ketone, 4,4′-bis(diethylamino)benzophenone, xanthone, thioxanthone, isopropylxanthone, 2,4-diethylthioxanthone, 2-ethylanthraquinone, acetophenone, 2-hydroxy-2-methylpropiophenone, 2-hydroxy-2-methyl-4′-isopropylpropiophenone, 1-hydroxycyclohexyl phenyl ketone, isopropylbenzoin ether, isobutylbenzoin ether, 2,2-diethoxyacetophenone, 2,2-dimethoxy-2-phenylacetophenone, benzyl, camphorquinone, benzanthrone, 2-methyl-1-[4-(methylthio)phenyl]-2-morpholinopropan-1-one, ethyl 2-benzyl-2-dimethylamino-1-(4-morpholinophenyl)-butanone-1,4-dimethylamino benzoate, isoamyl 4-dimethylaminobenzoate, 3,4,4′-tri(t-butylperoxycarbonyl)benzophenone, 3,5,4′-tri(t-butylperoxycarbonyl)benzophenone, 3,4,5-tri(t-butylperoxycarbonyl)benzophenone, 2,3,4-tri(t-butylperoxycarbonyl)benzophenone, 3,4,4′-tri(t-amylperoxycarbonyl)benzophenone, 3,4,4′-tri(t-hexylperoxycarbonyl)benzophenone, 3,4,4′-tri(t-octylperoxycarbonyl)benzophenone, 3,3,4′-tri(t-cumylperoxycarbonyl)benzophenone, 4-methoxy-2′,4′-di(t-butylperoxycarbonyl)benzophenone, 3-methoxy-2′,4′-di(t-butylperoxycarbonyl)benzophenone, 2-methoxy-2′,4′-di(t-butylperoxycarbonyl)benzophenone, 4-ethoxy-2′,4′-di(t-butylperoxycarbonyl)benzophenone, 3,3′,4,4′-tetra(t-butylperoxycarbonyl)benzophenone, 3,3′,4,4′-tetra(t-hexylperoxycarbonyl)benzophenone, 2,4,6-trimethylbenzoyl-diphenylphosphine oxide, 2,4,6-trimethylbenzoyl-phenylphosphinic acid methyl ester, 2,4,6-trimethylbenzoyl-phenylphosphinic acid ethyl ester, 2,4-dichlorobenzoyl-diphenylphosphine oxide, 2,6-dichlorobenzoyl-diphenylphosphine oxide, 2,3,5,6-tetramethylbenzoyl-diphenylphosphine oxide, 3,4-dimethylbenzoyl-diphenylphosphine oxide, bis(2,4,6-trimethylbenzoyl)-phenylphosphine oxide, bis(2,6-dimethoxybenzoyl)-2,4,4-trimethyl-pentylphosphine oxide, 4-[p-N,N-di(ethoxycarbonylmethyl)]-2,6-di(trichloromethyl)-s-triazine, 1,3-bis(trichloromethyl)-5-(2′-chlorophenyl)-s-triazine and 1,3-bis(trichloromethyl)-5-(4′-methoxyphenyl)-s-triazine. These may be used individually or in combination.

Among them, preferred are 4,4′-bis(diethylamino)benzophenone, 2-methyl-1-[4-(methylthio)phenyl]-2-morpholinopropan-1-one, 2-benzyl-2-dimethylamino-1-(4-morpholinophenyl)-butanone-1,3,4,4′-tri(t-butylperoxycarbonyl)benzophenone and 3,3′,4,4′-tetra(t-hexylperoxycarbonyl)benzophenone. Particularly preferred are a combinational use of 4,4′-bis(diethylamino)benzophenone and 3,4,4′-tri(t-butylperoxycarbonyl)benzophenone, a combinational use of 4,4′-bis(diethylamino)benzophenone, 3,4,4′-tri(t-butylperoxycarbonyl)benzophenone, and 2-benzyl-2-dimethylamino-1-(4-morpholinophenyl)-butanone-1, and a combinational use of 4,4′-bis(diethylamino)benzophenone, 3,4,4′-tri(t-butylperoxycarbonyl)benzophenone, 2-benzyl-2-dimethylamino-1-(4-morpholinophenyl)-butanone-1 and 2-methyl-1-[4-(methylthio)phenyl]-2-morpholinopropan-1-one, from the viewpoints of attaining high sensitivity, high compatibility to resin, high storage stability and good pattern edge shape.

The amount of the photoradical generator or sensitizer is preferably 0.1% by mass to 50% by mass, more preferably 0.5% by mass to 40% by mass, with respect to the random copolymer. When the amount is less than 0.1% by mass, practically satisfactorily sensitivity may not be obtained. Whereas when the amount is more than 50% by mass, bleeding-out of the photoradical generator or sensitizer, or a drop in developability may occur.

### —Polymerizable Monomer—

The polymerizable monomer used in combination with the photoradical generator or sensitizer is not particularly limited and may be appropriately selected depending on the purpose. Examples thereof include polyfunctional monomers such as trimethylolpropane triacrylate, pentaerythritol triacrylate, pentaerythritol tetraacrylate, dipentaerythritol pentaacrylate, dipentaerythritol hexaacrylate, trisacryloyloxyethyl phosphate, polyethylene glycol diacrylate, isocyanuric acid ethylene oxide-modified triacrylate, isocyanuric acid ethylene oxide-modified diacrylate, polyester acrylate and diglycerine tetraacrylate. These may be individually or in combination.

Among them, pentaerythritol triacrylate, pentaerythritol tetraacrylate, dipentaerythritol pentaacrylate, dipentaerythritol hexaacrylate, trisacryloyloxyethyl phosphate and polyethylene glycol diacrylate are particularly preferred, with dipentaerythritol pentaacrylate, dipentaerythritol hexaacrylate being particularly preferred.

Notably, it is effective to use monofunctional or difunctional monomers such as polyethylene glycol diacrylate, phthalic acid monohydroxyethyl acrylate, KAYARAD TC-110S, KAYARAD R-712, KAYARAD R-551 and KAYARAD R-684 (these products are of NIPPON KAYAKU Co., Ltd.) in an amount of 2% by mass to 40% by mass with respect to the total amount of all the polymerizable monomers.

The amount of the polymerizable monomer is preferably 20 parts by mass to 200 parts by mass, more preferably 30 parts by mass to 150 parts by mass, per 100 parts by mass of the random copolymer. When the amount is less than 20 parts by mass, practically satisfactorily sensitivity may not be obtained. Whereas when the amount is more than 200 parts by mass, potentially, the film surface after drying becomes sticky, the production yield decreases due to adhesion of dust, and the film thickness becomes large, which is disadvantageous.

### —Azide Compound Generating Nitrene Through Irradiation of Light—

The azide compound generating nitrene through irradiation of light is not particularly limited and may be appropriately selected depending on the purpose. Examples thereof include 4,4′-diazidechalcone, sodium 4,4′-diazidestilbene-2,2′-disulfonate, 4,4′-diazidediphenylmethane, 2,6-bis(4′-azidebenzal)-4-methylcyclohexanone, 4,4′-diazidestilbene-2,2′-bis(hydroxypropylsulfoneamide), 2,6-bis(4-azidebenzylidene)cyclohexanone, 2,6-bis(4-azidebenzylidene)-4-methylcyclohexanone, 2,6-bis(4-azidebenzylidene)-4-ethylcyclohexanone and 2,6-bis(4-azidebenzylidene)-4-butylcyclohexanone. These may be used individually or in combination.

The azide compound reacts with the photosensitive group in the random copolymer. When the azide compound is used as the photosensitive compound, it is not necessary that the photoradical generator or polymerizable monomer is used in combination. But, it is necessary that a cyclohexene ring or pyrrolidone ring, which is capable of reacting with the azide compound, is introduced into the copolymer used in the present invention. The method for introducing such ring is not particularly limited, but in the simplest method, the compound represented by General Formula (1) is copolymerized with, for example, (meth)acrylate or vinylpyrrolidone having a cyclohexene ring or a pyrrolidone ring.

The amount of the azide compound is preferably 2% by mass to 30% by mass with respect to the random copolymer. When the amount is less than 2% by mass, practically satisfactorily sensitivity may not be obtained. When the amount is more than 30% by mass, coloring of the azide compound considerably occurs, potentially leading to reduction in transparency.

### <Nanowire Structure>

The nanowire structure is not particularly limited, so long as it has conductivity and a nanowire structure, and may be appropriately selected depending on the purpose. Examples thereof include metal oxides such as ITO, zinc oxide and tin oxide; carbon nanotubes, elemental metals, core-shell structures formed of a plurality of metal elements, alloys and plated metal nanowires, with metal nanowires and carbon nanotubes being preferred, with metal nanowires being particularly preferred.

In the present invention, the nanowire structure refers to a structure having an aspect ratio (major axis length/minor axis length) of 30 or greater.

### —Carbon Nanotube—

Carbon nanotubes are a tubular carbon structure formed of elongated carbon fibers each having a diameter of 1 nm to 1,000 nm, a length of 0.1 μm to 1,000 μm, and an aspect ratio of 100 to 10,000.

Known methods for producing carbon nanotubes include an arc-discharge method, a laser evaporation method, a thermal CVD method and a plasma CVD method. Carbon nanotubes formed by the arc-discharge method and laser evaporation method are classified into single wall nanotubes (SWNTs) formed of only one graphene sheet and multi wall nanotubes (MWNTs) formed of a plurality of graphene sheets.

The thermal CVD method and plasma CVD method can produce MWNTs mainly. The SWNTs have a tubular structure formed by curling one graphene sheet in which carbon atoms are hexagonally bonded to one another via strong bonds called an SP2 bond.

Carbon nanotubes (SWNTs or MWNTs) are a tubular substance having a structure formed by curling one to several graphene sheets, and having a diameter of 0.4 nm to 10 nm and a length of 0.1 μm to several hundreds micrometers. Depending on the direction in which the graphene sheet(s) is(are) curled, the formed carbon nanotubes have unique properties that they become a metal or semiconductor.

### —Metal Nanowire—

The diameter (minor axis length) of the metal nanowire is preferably 300 nm or less, more preferably 200 nm or less, yet more preferably 100 nm or less. When the diameter thereof is too small, the antioxidation property thereof is degraded, potentially degrading the durability of the metal nanowire. Therefore, the diameter of the metal nanowire is preferably 5 nm or more. When the diameter thereof is more than 300 nm, there may be cases where sufficient transparency cannot be attained, probably because scattering occurs due to the metal nanowires.

The length (major axis length) of the metal nanowire is preferably 5 μm or more, more preferably 15 μm or more, yet more preferably 25 μm or more. When the major axis length of the metal nanowire is too long, aggregated matters may be generated during the production process, probably because the metal nanowires are tangled each other. Therefore, the major axis length of the metal nanowire is preferably 1 mm or less, more preferably 500 μm or less. When the major axis length of the metal nanowire is less than 5 μm, sufficient conductivity may not be attained probably because it is difficult to form a dense network.

Here, the diameter and major axis length of the metal nanowire can be obtained, for example, by using a transmission electron microscope (TEM) and an optical microscope, and observing images of TEM or the optical microscope. In the present invention, the diameter and major axis length of the metal nanowire are obtained by observing three hundred metal nanowires by means of a transmission electron microscope (TEM), and calculating the average values thereof.

In the present invention, the metal nanowires each having a diameter of 50 nm or less and a major axis length of 5 μm or more are contained in the total metal particles preferably in an amount of 50% by mass or more, more preferably 60% by mass or more, yet more preferably 75% by mass or more on the basis of the metal content.

When the proportion of the metal nanowires each having a diameter of 50 nm or less and a major axis length of 5 μm or more (hereinafter, may be referred as an appropriate wire yield) is less than 50% by mass, the conductivity may be lowered probably because the metal content contributing to the conductivity is reduced, and the durability may be degraded probably because a dense wire network cannot be formed at the same time to thereby cause a voltage concentration. Moreover, in the case where the plasmon absorption of particles having the shape other than the nanowire is strong, such as the case of spherical particles, the transparency may be degraded.

Here, the appropriate wire yield can be obtained, for example when the metal nanowire is a silver nanowire, by filtering silver nanowire aqueous solution so as to separate the silver nanowires from the other particles, and measuring the amount of Ag remained on the filter paper, and the amount of Ag passed through the filter paper, respectively, by means of ICP Atomic Emission Spectrometer. The metal nanowires remained on the filter paper are observed under a TEM, among them the diameters of the three hundred metal nanowires are observed, and check the distribution thereof, to thereby confirm that they are the metal nanowires having a diameter of 50 nm or less and a major axis length of 5 μm or more. Note that, as the filter paper, those having a pore size which is five times or more of the maximum major axis length of particles other than the metal nanowires each having a diameter of 50 nm or less and a major axis length of 5 μm or more measured through TEM, and which is ½ or less of the minimum major axis length of the metal nanowires are preferably used.

The variation coefficient of the diameters of the metal nanowires is preferably 40% or less, more preferably 35% or less, yet more preferably 30% or less.

When the variation coefficient is more than 40%, the durability may be degraded probably because the voltage is concentrated on wires having small diameters.

The variation coefficient of the diameters of the metal nanowires can be obtained, for example, by measuring diameters of three hundred metal nanowires on an image of transmission electron microscope (TEM), and calculating the standard deviation and average value thereof.

The shape of the metal nanowires may be any shape such as a cylindrical columnar shape, a rectangular parallelepiped shape, and a columnar shape with a polygonal cross-section. When high transparency is required in their use, the shape of the metal nanowires is preferably a cylindrical columnar shape or a columnar shape with a polygonal cross-section having round corners.

The shape of cross-section of the metal nanowires may be confirmed as follows. Specifically, a water dispersion of the metal nanowires is applied on a substrate, and their cross-sections are observed under a transmission electron microscope (TEM).

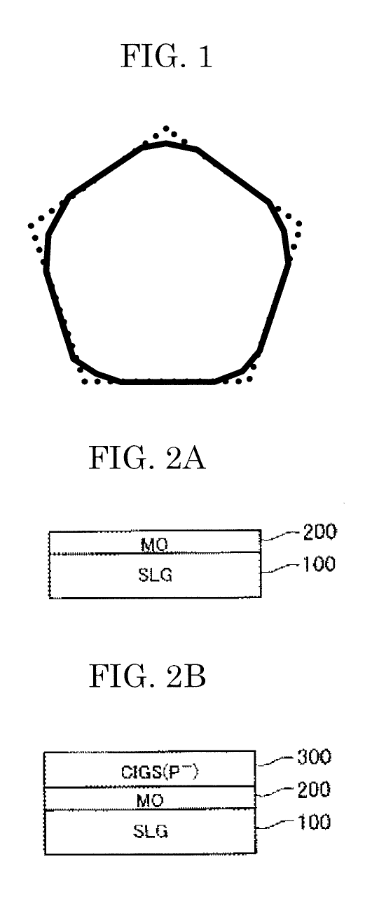

A corner of the cross-section of the metal nanowires means a part around an intersection point of the two extended straight lines from the neighboring sides of the cross-section. “Side of the cross-section” means a straight line segment connecting two neighboring corners of the cross-section. Here, a “degree of sharpness” is defined as a percentage of “the length of the periphery of the cross-section” to the total length of all “sides of the cross-section.” For example, in a cross-section of a metal nanowire shown in FIG. 1, the degree of sharpness can be expressed as a percentage of the length of the periphery of the cross-section indicated by a solid curving line to the length of the periphery of a pentagon indicated by dotted straight line segments. The shape of a cross-section having a degree of sharpness of 75% or less is defined as the shape of the “cross-section having round corners.” The degree of the cross section is preferably 60% or less, more preferably 50% or less. When the degree of sharpness is more than 75%, the transparency may be degraded with a remaining yellowish color, probably because electrons are localized in the corners to enhance plasmon absorption.

A metal used for the metal nanowires is not particularly limited in terms of the selection thereof, and any metal can be used for the metal nanowires. In addition to using one metal, two or more metals may be used in combination, or as an alloy. Among them, those formed of a metal or a metal compound are preferable, and those formed of a metal are more preferable.

The metal is preferably at least one metal selected from the 4^{th}, 5^{th} and 6^{th} periods of the long form of Periodic Table (IUPAC 1991), more preferably from the 2^{nd} to 14^{th} groups thereof, and yet more preferably from the 2^{nd} group, the 8^{th} group, 9^{th} group, 10^{th} group, 11^{th} group, 12^{th} group, 13^{th} group and 14^{th} group. Moreover, it is particularly preferred that at least one of the aforementioned elements be contained in the metal as a main component.

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead and alloys thereof. Among them, copper, silver, gold, platinum, palladium, nickel, tin, cobalt, rhodium, iridium and alloys thereof are preferable, palladium, copper, silver, gold, platinum, tin and alloys thereof are more preferable, and silver and alloy containing silver are particularly preferable.

### —Production Method for Metal Nanowire—

The method for producing the metal nanowires is not particularly limited and may be any method. Preferably, as described below, the metal nanowires are produced by reducing metal ions in a solvent containing a halogen compound and a dispersing agent.

As the solvent, a hydrophilic solvent is preferable. Examples of the hydrophilic solvent include: water; alcohols such as methanol, ethanol, propanol, isopropanol, butanol and ethylene glycol; ethers such as dioxane and tetrahydrofuran; and ketenes such as acetone.

The heating temperature is preferably 250° C. or less, more preferably 20° C. to 200° C., yet more preferably 30° C. to 180° C., particularly preferably 40° C. to 170° C. If necessary, the temperature may be changed during the formation of particles. To change the temperature in the course of the formation of particles may contribute to the control for the formation of the core, preventing the generation of re-grown cores and promoting selective growth to improve the monodispersibility.

When the heating temperature is more than 250° C., the transmittance may be lowered in terms of the evaluation of the coated film, probably because the angles of the cross section of the metal nanowire become sharp. Moreover, as the heating temperature is getting lower, the metal nanowires tends to tangle and dispersion stability thereof is lowered, probably because the yield of core formation is lowered and the metal nanowires become too long. This tendency becomes significant at the heating temperature of 20° C. or less.

It is preferred that the reducing agent be added at the time of the heating. The reducing agent is suitably selected from those generally used without any restriction. Examples of the reducing agent include: metal salts of boron hydrides such as sodium boron hydride and potassium boron hydride; aluminum hydride salts such as lithium aluminum hydride, potassium aluminum hydride, cesium aluminum hydride, beryllium aluminum hydride, magnesium aluminum hydride and calcium aluminum hydride; sodium sulfite; hydrazine compounds; dextrin; hydroquinones; hydroxylamines; citric acid and salts thereof; succinic acid and salts thereof; ascorbic acid and salts thereof; alkanol amines such as diethylamino ethanol, ethanol amine, propanol amine, triethanol amine and dimethylamino propanol; aliphatic amines such as propyl amine, butyl amine, dipropylene amine, ethylene diamine and triethylenepentamine; heterocyclic amines such as piperidine, pyrrolidine, N-methylpyrrolidine and morpholine; aromatic amines such as aniline, N-methyl aniline, toluidine, anisidine and phenetidine; aralkyl amines such as benzyl amine, xylene diamine and N-methylbenzyl amine; alcohols such as methanol, ethanol and 2-propanol; ethylene glycol; glutathione; organic acids such as citric acid, malic acid and tartaric acid; reducing sugars such as glucose, galactose, mannose, fructose, sucrose, maltose, raffinose and stachyose; and sugar alcohols such as sorbitol. Among them, the reducing sugars, sugar alcohols that are derivatives of the reducing sugars, and ethylene glycol are particularly preferable.

Note that, there is a case where the reducing agents may also function as a dispersing agent or a solvent depending on the types of the reducing agents, and those reducing agents are also preferably used.

The timing when the reducing agent is added may be before or after addition of a dispersing agent, and may be before or after addition of a halogen compound or halogenated metal fine particles.

The metal nanowires are preferably produced through addition of a dispersing agent and a halogen compound or halogenated metal fine particles.

The timing when the dispersing agent and halogen compound are added may be before or after addition of the reducing agent, and may be before or after addition of the metal ions or halogenated metal fine particles. For producing nanowires having better monodispersibility, the halogen compound is preferably added twice or more times in a divided manner, probably because core formation and growth can be controlled.

The timing when the dispersing agent is added may be before preparation of particles in the presence of dispersion polymer, or after preparation of particles for controlling the dispersion state of the particles. In the case where the addition of the dispersing agent is carried out twice or more times, the amount of the dispersion agent to be added each time needs to be adjusted depending on the desired length (major axis length) of wires. This is because it is considered that the length of wires depends on the control of the amount of the metal particles serving as cores.

Examples of the dispersing agent include amino group-containing compounds, thiol group-containing compounds, sulfide group-containing compounds, amino acids or derivatives thereof, peptide compounds, polysaccharides, natural polymers derived from polysaccharides, synthetic polymers, and polymers derived from those mentioned above such as gels.

Examples of the polymers include protective colloid polymers such as gelatin, polyvinyl alcohol (P-3), methyl cellulose, hydroxypropyl cellulose, polyalkylene amine, partial alkyl ester of polyacrylic acid, polyvinyl pyrrolidone and polyvinyl-pyrrolidine copolymer.

The compound structures usable for the dispersing agent can be, for example, referred to the description in “Pigment Dictionary” (edited by Seishiro Ito, published by ASAKURA PUBLISHING CO., (2000)).

Depending on the type of the dispersing agent for use, the shapes of obtained metal nanowires can be changed.

The halogen compound is suitably selected depending on the intended purpose without any restriction, provided that the compound contains bromine, chlorine, or iodine. Preferable examples of the halogen compound include: alkali halide such as sodium bromide, sodium chloride, sodium iodide, potassium bromide, potassium chloride and potassium iodide; and compounds that can be used together with the dispersing agent described below. The timing when the halogen compound is added may be before or after addition of the dispersing agent, and before or after addition of the reducing agent.

Note that, there may be a case where the halogen compounds may also function as a dispersing agent depending on the types of the halogen compounds, and those halogen compounds are also preferably used.

Halogenated silver fine particles may be used instead of the halogen compound, or the halogen compound and the halogenated silver fine particles may be used in combination.

The single compound may be used as the dispersing agent and the halogen compound or halogenated silver fine particles. The compound used for both the dispersing agent and the halogen compound is, for example, hexadecyl-trimethylammonium bromide (HTAB) containing an amino group and a bromide ion, or hexadecyl-trimethylammonium chloride (HTAC) containing an amino group and a chloride ion.

The desalination can be carried out by ultrafiltration, dialysis, gel filtration, decantation, centrifugal separation, or the like, after formation of the metal nanowires.

It is preferred that the metal nanowires do not contain inorganic ions such as alkali metal ions, alkaline earth metal ions and halide ions to the greatest extent possible. The electric conductivity of an aqueous dispersion which has been prepared by dispersing the metal nanowires in pure water is preferably 1 mS/cm or less, more preferably 0.1 mS/cm or less, yet more preferably 0.05 mS/cm or less.

The viscosity of an aqueous dispersion which has been prepared by dispersing the metal nanowires in pure water is preferably 0.5 mPa·s to 100 mPa·s, more preferably 1 mPa·s to 50 mPa·s at 20° C.

The amount of the nanowire structure contained in the photosensitive composition is preferably 10 parts by mass to 500 parts by mass, more preferably 20 parts by mass to 300 parts by mass, on the basis of 100 parts by mass of the random copolymer.

When the amount of the nanowire structure is less than 10 parts by mass, the coating amount required for obtaining conductivity becomes large, potentially increasing load in drying and developing steps. Whereas when the amount thereof is more than 500 parts by mass, the developability, especially the resolution may be degraded.

In addition to the random copolymer, photosensitive compound and nanowire structure, if necessary, the photosensitive composition of the present invention may contain various additives such as a surfactant, an antioxidant, a sulfurization inhibitor, a metal corrosion inhibitor, a viscosity adjuster and an antiseptic agent.

The metal corrosion inhibitor is not particularly limited and may be appropriately selected depending on the purpose. Preferred examples thereof include thiols and azoles.

Examples of the azoles include benzotriazole, tolyltriazole, mercaptobenzothiazole, mercaptobenzotriazole, mercaptobenzotetrazole, (2-benzothiazolylthio)acetic acid and 3-(2-benzothiazolylthio)propionic acid.

Examples of the thiols include alkanethiols and fluorinated alkanethiols. Specific examples thereof include dodecanethiol, tetradecanethiol, hexadecanethiol, octadecanethiol, fluorodecanethiol; and alkali metal salts thereof; ammonium salts thereof; and amine salts thereof. And, at least one of them can be used. The metal corrosion inhibitor can impart more excellent corrosion inhibitory effect to the composition. The metal corrosion inhibitor may be dissolved in an appropriate solvent and added to a solution prepared by dissolving the photosensitive composition in a solvent, or may be added to the solution in the form of powder. Alternatively, the below-described patterned transparent conductive film formed from the photosensitive composition may be immersed in a metal corrosion inhibitor-containing bath for imparting corrosion inhibitory effect to it.

### —Solvent—

The solvent is preferably those capable of dissolving the random copolymer and the photosensitive compound.

Examples of the solvent include ethanol, 2-propanol, 2-butanone, ethyl acetate, butyl acetate, ethylene glycol monoisopropyl ether, ethylene glycol monobutyl ether, ethyl carbitol, propylene glycol monomethyl ether, propylene glycol monomethyl ether acetate, ethylene glycol monobutyl ether acetate, cyclohexanone, diethylene glyclol dimethyl ether, diethylene glycol diethyl ether, toluene, xylene, γ-butyrolactone and N,N-dimethylacetamide. These may be used individually or in combination.

Among them, propylene glycol monomethyl ether, propylene glycol monomethyl ether acetate, cyclohexanone and toluene are particularly preferred, since the film obtained after coating has a uniform thickness.

### <Developer>

A developer for developing the photosensitive composition of the present invention after exposure is preferably an alkaline solution. Examples of the alkali contained in the alkaline solution include tetramethylammonium hydroxide, tetraethylammonium hydroxide, 2-hydroxylethyltrimethylammonium hydroxide, sodium carbonate, sodium hydrogen carbonate, potassium carbonate, potassium hydrogen carbonate, sodium hydroxide potassium hydroxide. As the developer, an aqueous alkaline solution is preferably used.

Further, specific examples of the developer include organic alkaline compounds such as tetramethylammonium hydroxide, tetraethylammonium hydroxide and 2-hydroxylethyltrimethylammonium hydroxide; and aqueous solutions of inorganic alkaline compounds such as sodium carbonate, potassium hydroxide and potassium hydroxide.

In order to reduce the amount of residue after development and to form an appropriate patterned shape, a surfactant such as methanol or ethanol may be added to the developer. The surfactant may be an anionic surfactant, a cationic surfactant or a nonionic surfactant. Among them, polyoxyethylene alkyl ether (nonionic surfactant) is particularly preferably added to the developer, since the resolution is increased.

The developing method is not particularly limited and may be appropriately selected depending on the purpose. Examples thereof include dip development, paddle development and shower development.

### (Transparent Conductive Film)

A transparent conductive film of the present invention is relatively high in resolution during patterning, and suitably used for forming a patterned conductive film. Here, the conductive film refers, for example, to a film (interlayer conductive film) provided for attaining electrical conduction between elements arranged in the form of laminate as well as in the same layer.

The transparent conductive film is formed as follows.

Specifically, the photosensitive composition of the present invention is applied onto a substrate (e.g., a glass substrate) through known methods such as spin coating, roll coating and slit coating. Alternatively, nanowire structures may be applied in advance and then a photosensitive composition containing no nanowire structures may be applied thereon, followed by drying, to thereby prepare the photosensitive composition of the present invention. But, preferred is a photosensitive composition formed by applying once a dispersion of nanowire structures in a resin coating liquid.

The substrate is not particularly limited and may be appropriately selected depending on the purpose. Examples thereof include transparent glass substrates such as white plate glasses, blue plate glasses and silica-coated blue glasses; synthetic resin sheets, films and substrates made of, for example, polycarbonates, polyethersulfones, polyesters, acrylic resins, vinyl chloride resins, aromatic polyamide resins, polyamideimides and polyimides; metal substrates such as aluminum plates, copper plates, nickel plates and stainless plates; and semiconductor substrates having other ceramic plates and photoelectric conversion elements. These substrates may be pre-treated, as desired, through a chemical treatment using a silane coupling agent, a plasma treatment, ion plating, sputtering, a vapor phase reaction method, vacuum vapor deposition, etc.

Next, the substrate was dried with a hot plate or an oven, generally at 60° C. to 120° C. for 1 min to 5 min. The dried substrate was irradiated patternwise with LTV rays through a mask having a desired pattern. Preferably, i beams are applied at 5 mJ/cm² to 1,000 mJ/cm².

After development by a commonly used developing method (e.g., shower development, spray development, paddle development or dip development), the substrate is thoroughly rinsed with pure water. The entirety of the substrate is irradiated again with UV rays at 100 mJ/cm² to 1,000 mJ/cm², followed by firing at 180° C. to 250° C. for 10 min to 120 min, whereby a desirably patterned transparent film can be obtained.

The thus-obtained patterned transparent conductive film can also be used as a patterned conductive film. The shape of holes formed in the conductive film is preferably square, rectangular, circular or ellipsoidal when the holes are viewed from directly above. Further, a film for orientation treatment may be formed on the patterned conductive film. The conductive film has high solvent resistance and heat resistance. Thus, even when a film for orientation treatment is formed, the conductive film involves no wrinkles, maintaining high transparency.

### (Display Element)

A display element of the present invention is not particularly limited and may be appropriately selected depending on the purpose. Preferably, the display element is a liquid crystal display element.

The liquid crystal display element is formed from an element substrate having the patterned transparent conductive film in the above-described manner and a color filter substrate (counter substrate). Specifically, these substrates are positioned/pressure-bonded to each other and assembled through thermal treatment, and then liquid crystals are injected thereinto and finally, the inlet port is sealed. Preferably, a transparent conductive film formed on the color filter is also formed of the photosensitive composition of the present invention.

In an employable, alternative method for producing the liquid crystal display element, after liquid crystals have been spread on the element substrate, a substrate is superposed on the element substrate and the resultant product is sealed so that liquid crystals are not leaked.

In this manner, a highly transparent conductive film formed of the photosensitive composition of the present invention can be used in a liquid crystal display element.

Notably, liquid crystals (i.e., liquid crystal compounds and liquid crystal compositions) used in the liquid crystal display element are not particularly limited, and any liquid crystal compounds and liquid crystal compositions can be used.

### (Integrated Solar Battery)

An integrated solar battery of the present invention (hereinafter may be referred to as a “solar battery device”) is not particularly limited and may be the ones commonly used as a solar battery device.

Examples of the integrated solar battery include a single crystal silicon solar battery device, polycrystalline silicon solar battery device, an amorphous silicon solar battery device of a single junction or tandem structure, a III-V group compound semiconductor solar battery device using, for example, gallium arsenide (GaAs) and indium phosphide (InP), a II-VI group compound semiconductor solar battery device using, for example, cadmium tellurium (CdTe), a I-III-VI group compound semiconductor solar battery device of copper/indium/selenium type (so-called, CIS type), copper/indium/gallium/selenium type (so-called, CIGS type), or copper/indium/gallium/selenium/sulfur type (so-called, CIGSS type), a dye-sensitized solar battery device, and an organic solar battery device. Among them, in the present invention, the amorphous silicon solar battery device of a tandem structure, and the I-III-VI group compound semiconductor solar battery device of copper/indium/selenium type (so-called, CIS type), copper/indium/gallium/selenium type (so-called, CIGS type), or copper/indium/gallium/selenium/sulfur type (so-called, CIGSS type) are preferable.

In the case of the amorphous silicon solar battery device of, for example, a tandem structure, amorphous silicon, a microcrystal silicon thin layer, a thin layer formed by adding Ge to the amorphous silicon or the microcrystal silicon thin layer, or a tandem structure of two or more layers selected therefrom is used as a photoelectric conversion layer. For the formation of the layer, a plasma chemical vapor deposition (PCVD) or the like is used.

### [Production Method of Transparent Conductive Layer]

The transparent conductive layer for use in the integrated solar battery of the present invention is suitably applied for all of the solar battery devices listed above. The transparent conductive layer may be contained in any part of the solar battery device, but is preferably contained so as to be adjacent to the photoelectric conversion layer. With regard to the positioning of the transparent conductive layer and the photoelectric conversion layer, the structures listed below are preferable, but not limited thereto. Moreover, the structures below do not describe all of the parts constituting the solar battery device, and they only describe within the range where the positioning of the transparent conductive layer can be illustrated.

(A) substrate-transparent conductive layer (a product from the present invention)-photoelectric conversion layer
(B) substrate-transparent conductive layer (a product from the present invention)-photoelectric conversion layer-transparent conductive layer (a product from the present invention)
(C) substrate-electrode-photoelectric conversion layer-transparent conductive layer (a product from the present invention)
(D) back side electrode-photoelectric conversion layer-transparent conductive layer (a product from the present invention)

The method for forming the transparent conductive layer includes applying onto a substrate a coating liquid in which the nanowire structure has been dispersed and drying the coating liquid.

After application of the coating liquid, annealing may be carried out by heating. At the time of the annealing, the heating temperature is preferably 50° C. to 300° C., more preferably 70° C. to 200° C.

The method for applying the coating liquid is suitably selected depending on the intended purpose without any restriction. Examples thereof include web coating, spray coating, spin coating, doctor blade coating, screen printing, gravure printing and inkjet printing. Especially with the web coating, screen printing and inkjet printing, roll-to-roll production on a flexible substrate can be performed.

Non-limitative examples of the substrate are listed below.

(1) glass such as quartz glass, alkali-free glass, crystallized transparent glass, Pyrex (registered trademark) glass, sapphire
(2) thermoplastic resin such as acrylic resin (e.g. polycarbonate and polymethacrylate), polyvinyl chloride resin (e.g. polyvinyl chloride and vinyl chloride copolymer); polyacrylate; polysulfone; polyether sulfone; polyimide; PET; PEN; fluororesin; phenoxy resin; polyolefine resin; nylon; styrene resin; and ABS resin
(3) thermosetting resin such as epoxy resin

A surface of the substrate may be subjected to a treatment to give hydrophilicity thereto. Preferably, the substrate surface is coated with a hydrophilic polymer. By these treatments, coating performance and adhesion of the aqueous dispersion to the substrate are improved.

The treatment for hydrophilicity is suitably selected depending on the intended purpose without any restriction. Examples thereof include a chemical treatment, physical roughening, corona discharge, flame treatment, ultraviolet ray treatment, glow discharge, active plasma treatment and laser treatment. It is preferred that the surface tension of the surface of the substrate become 30 dyne/cm or more as a result of the surface treatment.

The hydrophilic polymer applied onto the substrate surface is suitably selected depending on the intended purpose without any restriction. Examples thereof include gelatin, gelatin derivatives, casein, agar, starch, polyvinyl alcohol, polyacrylic acid copolymer, carboxymethyl cellulose, hydroxyethyl cellulose, polyvinyl pyrrolidine and dextran.

The thickness of the hydrophilic polymer layer (in a dried state) is preferably 0.001 μm to 100 μm, more preferably 0.01 μm to 20 μm.

A hardening agent is preferably added to the hydrophilic polymer layer so as to increase the film strength. The hardening agent is suitably selected depending on the intended purpose without any restriction. Examples of thereof include: aldehyde compounds such as formaldehyde and glutaraldehyde; ketone compounds such as diacetyl and cyclopentanedione; vinyl sulfone compounds such as divinyl sulfone; triazine compounds such as 2-hydroxy-4,6-dichloro-1,3,5-triazine; and isocyanate compounds described in U.S. Pat. No. 3,103,437.

The hydrophilic polymer layer is formed by the following manner. Specifically, a coating liquid is prepared by dissolving and/or dispersing the aforementioned compound in a solvent such as water; and the obtained coating liquid is applied to a surface of the substrate, which has been treated to give hydrophilicity thereto by a coating method such as spin coating, dip coating, extrusion coating, bar coating and die coating, followed by drying. The drying temperature is preferably 120° C. or less, more preferably 30° C. to 100° C., yet more preferably 40° C. to 80° C.

Moreover, an undercoat layer may be formed between the substrate and the hydrophilic polymer layer for improving the adhesion therebetween.

### —CIGS Solar Battery—

Hereinafter, a CIGS solar battery is described in detail.

### —Structure of Photoelectric Conversion Layer—

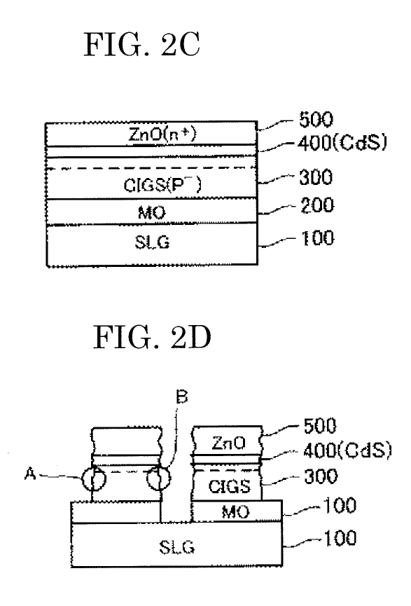

A thin film solar battery using CuInSe₂ (CIS thin film), which is a semiconductor thin film of a chalcopyrite structure consisting of a Ib group element, a IIIb group element and a VIb group element, or Cu(In,Ga)Se₂ (CIGS thin film), in which Ga is solid soluted to CuInSe₂, for a light absorption layer has high energy conversion efficiency, and, advantageously, the efficiency thereof is deteriorated due to light radiation in only a small degree. FIGS. 2A to 2D are cross sectional diagrams of the device for explaining the conventional production method of the cell of a CIGS thin film solar battery.

As shown in FIG. 2A, first, a molybdenum (Mo) electrode layer 200, which will be a lower electrode with respect to the plus side, is formed on a substrate 100. Then, as shown in FIG. 2B, a light absorption layer 300 formed of CIGS thin film exhibiting p⁻ type property as a result of the adjustment of the composition is formed on the Mo electrode layer 200. Subsequently, as shown in FIG. 2C, a buffer layer 400 of CdS or the like is formed on the light absorption layer 300, and a transparent electrode 500, which exhibits n⁺ type property by the doping of impurities, serves as an upper electrode at the minus side and is formed of zinc oxide (ZnO), is formed on the buffer layer 400. Here, the transparent conductive film of the present invention is laminated on ZnO or used instead of ZnO, to thereby obtain the solar battery device of the present invention. As shown in FIG. 2D, scribing processing is carried out at the same time from the transparent electrode layer 500 of ZnO to the Mo electrode layer 200 by means of a mechanical scribe device. By this processing, each cell of the thin film solar battery is electrically separated (i.e., each cell is individualized). The compounds with which a film can be suitably formed in this embodiment are listed below.

(1) Compounds containing an element, a compound or an alloy that becomes a liqud phase at ambient temperature or by heating
(2) Chalcogen compound (compound containing S, Se and Te)

II-VI group compound: ZnS, ZnSe, ZnTe, CdS, CdSe, CdTe, etc.

I-III-VI₂ group compound: CuInSe₂, CuGaSe₂, Cu(In,Ga)Se₂, CuInS₂, CuGaSe₂, Cu(In,Ga)(S,Se)₂, etc.

I-III₃-VI₅ group compound: CuIn₃Se₅, CuGa₃Se₅, Cu(In,Ga)₃Se₅, etc.

(3) Compound of chalcopyrite structure and Compound of defect stannite structure

I-III-VI₂ group compound: CuInSe₂, CuGaSe₂, Cu(In,Ga)Se₂, CuInS₂, CuGaSe₂, Cu(In,Ga)(S,Se)₂, etc.

I-III₃-VI₅ group compound: CuIn₃Se₅, CuGa₃Se₅, Cu(In,Ga)₃Se₅, etc.

Note that, in the above, (In,Ga) and (S,Se) respectively represent (In₁₋ₓGaₓ) and (S_{1-y}Se_{y}), where x=0 to 1 and y=0 to 1.

Hereinafter, typical examples of the formation method of CIGS layer are described, but the formation method thereof is not limited to these examples.

### 1) Multiple Source Simultaneous Deposition

The typical methods of the multiple source simultaneous deposition are a three-stage deposition method developed by NREL (National Renewable Energy Laboratory), USA, and a simultaneous deposition method developed by EC Group. The three-stage deposition is described, for example, in J. R. Tuttle, J. S. Ward, A. Duda, T. A. Berens, M. A. Contreras, K. R. Ramanathan, A. L. Tennant, J. Keane, E. D. Cole, K. Emery and R. Noufi: Mat. Res. Soc. Symp. Proc., Vol. 426 (1996) p. 143. Moreover, the simultaneous deposition method is described, for example, in L. Stolt et al.: Proc. 13th ECPVSEC (1995, Nice) 1451.

The three-stage deposition is a method in which In, Ga and Se are simultaneously deposited at the substrate temperature of 300° C. in high vacuum, then the temperature is elevated to 500° C. to 560° C. to thereby simultaneously deposit Cu and Se, and thereafter In, Ga, and Se are simultaneously deposited again to thereby obtain a graded band gap CIGS film a forbidden band width of which is inclined. The method of EC Group is a method which improves a bilayer deposition method developed by Boeing, in which Cu excess CIGS is deposited at the initial state and In excess CIGS is deposited in a later stage, so as to be able to be applied to the inline process. The bilayer deposition method is described in W. E. Devaney, W. S. Chen, J. M. Stewart, and R. A. Mickelsen: IEEE Trans. Electron. Devices 37 (1990) 428.

Both of the three-stage deposition method and the simultaneous deposition method of EC Group form Cu excess CIGS film composition in the process of growing the film and utilize a liquid phase sintering of the liquid phase Cu₂₋ₓSe (x=0 to 1) which is obtained from the phase separation from the Cu excess CIGS. Therefore, advantageously, large grains grow and the CIGS film having excellent crystallinity can be obtained in these methods.

Furthermore, various methods have recently been studied to modify the method mentioned above for improving the crystallinity of the CIGS film, and these methods can also be used.

### (a) Method Using Ionized Ga

This is a method to ionize Ga by passing evaporated Ga through a grid on which thermions generated by a filament are present so that the evaporated Ga collides against the thermions. The ionized Ga is accelerated by extraction voltage and then supplied to the substrate. The details thereof are described in H. Miyazaki, T. Miyake, Y. Chiba, A. Yamada, M. Konagai, phys. stat. sol. (a), Vol. 203 (2006) p. 2603.

### (b) Method Using Cracked Se

The evaporated Se generally forms clusters, but it is a method to make Se clusters lower molecules by thermally decomposing the Se clusters by means of a high temperature heater (Proceedings of the 68th Meeting of The Japan Society of Applied Physics (Hokkaido Institute of Technology, autumn, 2007) 7P-L-6).

### (c) Method Using Radicalized Se

This is a method using Se radicals generated by a bulb tracking device (Proceedings of the 54th Meeting of The Japan Society of Applied Physics (Aoyama Gakuin University, spring, 2007) 29P-ZW-10).

### (d) Method Using a Photoexcitation Process

This is a method in which KrF excimer laser light (e.g., wavelength of 248 nm, 100 Hz) or YAG laser light (e.g., wavelength of 266 nm, 10 Hz) is applied to a surface of a substrate during three-stage deposition (Proceedings of the 54th Meeting of The Japan Society of Applied Physics (Aoyama Gakuin University, spring, 2007) 29P-ZW-14).

### 2) Selenidation Method

The selenidation method is also called a two-step deposition method. In this method, a metal precursor of a laminate film such as Cu layer/In layer or (Cu—Ga) layer/In layer is formed by sputtering, deposition, electrodeposition, or the like, then the formed film is heated up to about 450° C. to about 550° C. in selenium vapor or hydrogen selenide to thereby produce a selenium compound such as Cu(In₁₋ₓGaₓ)Se₂ as a result of a thermal diffusion reaction. This method is called a vapor phase selenidation method, but other than this, there is a solid phase selenidation method in which a solid phase of selenium is deposited on a metal precursor film, and the solid phase of the selenium is selenided by a solid diffusion reaction using the solid phase of selenium as a selenium source. The only method which has currently been succeeded in mass production of a large area is a selenidation method in which a metal precursor film is formed by sputtering, which is suitable for production of large area, and the metal precursor is selenided in hydrogen selenide.

According to this method, however, the film expands about twice in its volume at the time of selenidation, and thus the internal strain is generated, and voids of about a few micrometers are formed in the formed film. These internal strain and voids adversely affect the adhesion to the substrate or properties of the solar battery and become factors to limit the photoelectric conversion efficiency (B. M. Basol, V. K. Kapur, C. R. Leidholm, R. Roe, A. Halani, and G. Norsworthy: NREL/SNL Photovoltaics Prog. Rev. Proc. 14th Conf.-A Joint Meeting (1996) AIP Conf. Proc. 394).

In order to avoid such rapid cubic expansion of the film at the time of the selenidation, a method in which selenium is previously added to the metal precursor film at a certain ratio (T. Nakada, R. Ohnishi, and A. Kunioka: “CuInSe₂-Based Solar Cells by Se-Vapor Selenization from Se-Containing Precursors” Solar Energy Materials and Solar Cells 35 (1994) pp. 204-214), and use of a multilayer precursor film in which selenium is placed between metal thin films (e.g., laminating Cu layer/In layer/Se layer . . . Cu layer/In layer/Se layer) (T. Nakada, K. Yuda, and A. Kunioka: “Thin Films of CuInSe₂ Produced by Thermal Annealing of Multilayers with Ultra-Thin stacked Elemental Layers” Proc. of 10th European Photovoltaic Solar Energy Conference (1991) pp. 887-890) have been proposed. By these, the aforementioned problem of the expansion of the deposition can be avoided in a certain degree.

However, there is a problem that is applied to all methods of selenidation, including the methods described above. That is a problem that there is an extremely low degree of freedom for controlling the film composition, when the metal laminate film whose composition is set is used from the beginning and this is then selenided. For example, a graded band gap CIGS thin film in which the Ga concentration is gradually changed in the thickness direction is currently used for the high efficiency CIGS solar battery. In order to form such thin film by the selenidation method, there is a method in which a Cu—Ga alloy film is deposited at first, and the Ga concentration is made gradually changed in the thickness direction using natural thermal diffusion at the time of the selenidation (K. Kushiya, I. Sugiyama, M. Tachiyuki, T. Kase, Y. Nagoya, O. Okumura, M. Sato, O. Yamase and H. Takeshita: Tech. Digest 9th Photovoltaic Science and Engineering Conf. Miyazaki, 1996 (Intn. PVSEC-9, Tokyo, 1996) p. 149).

### 3) Sputtering Method

As sputtering is suitable for a deposition of a large area, various methods have been proposed as a formation method of a CuInSe₂ thin film. Examples thereof include a method using CuInSe₂ polycrystal as a target, and a two-source sputtering method in which Cu₂Se and In₂Se₃ are used as a target, and mixed gas of H₂Se and Ar are used as sputtering gas (J. H. Ermer, R. B. Love, A. K. Khanna, S.C. Lewis and F. Cohen: “CdS/CuInSe₂ Junctions Fabricated by DC Magnetron Sputtering of Cu₂Se and In₂Se₃ “Proc. 18th IEEE Photovoltaic Specialists Conf. (1985) pp. 1655-1658). Moreover, there has been proposed a three-source sputtering method in which a Cu target, In target and Se or CuSe target is sputtered in Ar gas (T. Nakada, K. Migita, A. Kunioka: “Polycrystalline CuInSe₂ Thin Films for Solar Cells by Three-Source Magnetron Sputtering” Jpn. J. Appl. Phys. 32 (1993) L1169-L1172, and T. Nakada, M. Nishioka, and A. Kunioka: “CuInSe₂ Films for Solar Cells by Multi-Source Sputtering of Cu, In, and Se—Cu Binary Alloy” Proc. 4th Photovoltaic Science and Engineering Conf. (1989) 371-375).

### 4) Hybrid Sputtering Method

Suppose that the problem of the aforementioned sputtering method is damage on a surface of the film due to Se negative ions or high energy Se particles, this can be avoided by changing only Se to thermal vapor. Nakata et al. have formed a CIS thin film having a small number of defects by a hybrid sputtering method in which the metals of Cu and In are deposited by DC sputtering and only Se is deposited by vapor deposition, and have produced a CIS solar battery having a conversion efficiency of more than 10% (T. Nakada, K. Migita, S, Niki, and A. Kunioka: “Microstructural Characterization for Sputter-Deposited CuInSe₂ Films and Photovoltaic Devices” Jpn. Appl. Phys. 34 (1995) 4715-4721). Moreover, before Nakata et al., Rockett et al. reported a hybrid sputtering method for replacing toxic H₂Se gas with Se vapor (A. Rockett, T. C. Lommasson, L. C. Yang, H. Talieh, P. Campos and J. A. Thornton: Proc. 20th IEEE Photovoltaic Specialists Conf. (1988) 1505). Further back in the date, there was proposed a method in which sputtering was carried out in Se vapor so as to supplement insufficient Se in the film (S. Isomura, H. Kaneko, S. Tomioka, I. Nakatani, and K. Masumoto: Jpn. J. Appl. Phys. 19 (Suppl. 19-3) (1980) 23).

### 5) Mechanochemical Process

Raw materials for each composition of CIGS are placed into a container of a planetary ball mill, and then are mixed by physical energy to thereby obtain CIGS powder. Thereafter, it is applied onto a substrate by screen printing and subjected to annealing to thereby obtain a film of CIGS (T. Wada, Y. Matsuo, S, Nomura, Y. Nakamura, A. Miyamura, Y. Chia, A. Yamada, M. Konagai, Phys. stat. sol. (a), Vol. 203 (2006) p. 2593).

### 6) Other Methods

As other formation methods of a CIGS film, for example, screen printing, close space sublimation, MOCVD and spraying are used. In the screen printing, spraying and the like, a thin film consisting of fine particles formed of the components of a Ib group element, a Mb group element, a VIb group element and compounds thereof is formed on a substrate, and crystals of desired compositions are obtained by thermal treatment or thermal treatment in atmosphere of the VIb group element. For example, after coating oxide particles to thereby form a thin film, the thin film is heated in hydrogen selenide atmosphere. A thin film of an organic metal compound containing a PVSEC-17 PL5-3, or a metal-VIb group element bond is formed on a substrate by spraying or printing, followed by thermal decomposition, to thereby obtain a desired inorganic thin film. In case of S, examples thereof include metal mercaptide, thiosalt of metal, dithiosalt of metal, thiocarbonate of metal, dithiocarbonate of metal, trithiocarbonate of metal, thiocarbamate of metal and dithiocarbamate of metal (JP-A Nos. 09-74065 and 09-74213).

### —Value of Band Gap and Distribution Control—

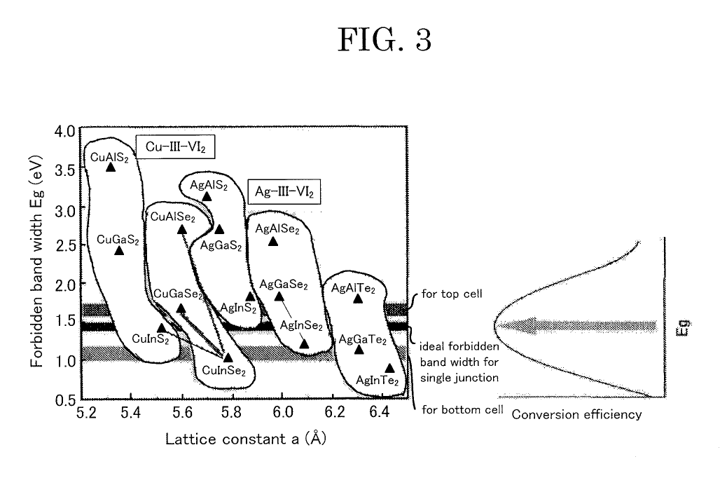

A semiconductor formed of various combinations of I group element-III group element-VI group element is preferably used for the light absorption layer of the solar battery. The one well known in the art is illustrated in FIG. 3. FIG. 3 is a diagram showing a relationship between a lattice constant and band gap of a semiconductor formed of Ib group element, Mb group element and VIb group element. Various forbidden band widths (band gaps) can be obtained by changing the composition ratio. In the case where photons of large energy are injected to the semiconductor by the band gap, the energy larger than the band gap is lost as heat. It has been known by a theoretical calculation that the maximum conversion efficiency with the combination of the spectrum of sun light and the band gap is about 1.4 eV to about 1.5 eV. For the purpose of increasing the conversion efficiency of the CIGS solar battery, for example, by increasing the concentration of Ga of Cu(InₓGa₁₋ₓ)S₂, the concentration of Al of Cu(InₓAlₓ)S₂, or the concentration of S of CuInGa(S,Se), the band gap of high conversion efficiency is obtained. In case of Cu(InₓGa₁₋ₓ)S₂, the maximum conversion efficiency can be adjusted in the range of 1 eV to 1.68 eV.

Note that, in FIG. 3, Cu(In₁₋ₓGaₓ)Se₂(CIGS) is a mixed crystal of CuInSe₂ and CuGaSe₂. The forbidden band width can be controlled in the range of 1.04 eV to 1.68 eV by changing the Ga concentration x. Other mixed crystals are Cu(InAl)Se₂, Ag(InGa)Se₂, CuIn(S,Se)₂, AgIn(S,Se)₂.

Moreover, the band structure can be graded by changing the composition ratio in the thickness direction of the film. There are two types of band gaps, which are a single graded band gap in which the band gap is increased in the direction from the light incident side to the opposite electrode side, and a double graded band gap in which the band gap is reduced in the direction from the light incident side to the PN junction part, and the band gap is increased as passed through the PN junction part. Such solar battery is disclosed, for example, in T. Dullweber, A new approach to high-efficiency solar cells by band gap grading in Cu(In,Ga)Se₂ chalcopyrite semiconductors, Solar Energy Materials & Solar Cells, Vol. 67, pp. 145-150 (2001). In any of these cases, carriers excited by light are accelerated and thus become easier to arrive at the electrode as the electric field is internally generated due to the graded band structure, and a chance of combination with recombination center is reduced, to thereby improve generating efficiency (International Publication No. WO 2004/090995).

### —Tandem Type—

By using a plurality of semiconductors each having different band gaps depending on the range of the spectrum, heat loss due to the deviation of photon energy and the band gap is reduced, and thus the generation efficiency can be increased. The one using a plurality of photoelectric conversion layers in lamination in the aforementioned manner is called a tandem type. In case of the two-layer tandem, the generation efficiency can be improved, for example, by using a combination of 1.1 eV and 1.7 eV.

### —Structure Other Than Photoelectric Conversion Layer—

For a n-type semiconductor which forms a junction with the I-III-VI group compound semiconductor, for example, II-VI group compounds such as CdS, ZnO, ZnS and Zn (O, S, OH) can be used. Use of these compounds are preferable as these compound can form a contact interface with the photoelectric conversion layer at which recombination of carriers are not occur (refer to JP-A No. 2002-343987).

### [Substrate]

As the substrate, for example, those listed below can be used. They are a glass plate such as soda-lime glass; a film of polyimide, polyethylene naphthalate, polyether sulfone, polyethylene terephthalate or aramide; a metal plate of stainless steel, titanium, aluminum or copper; and a laminate mica substrate described in JP-A No. 2005-317728. Among them, as the substrate for the element for use in the present invention, those having the shape of a film or a foil are preferable.

### [Backside Electrode]

For the backside electrode, for example, metals such as molybdenum, chrome, tungsten and the like can be used. These metal materials are preferable as they do not tend to mix with other layers even when subjected to a heat treatment. In the case where a photoelectromotive force layer containing a semiconductive layer (light absorption layer) formed of a I-III-VI group compound semiconductor is used, the molybdenum layer is preferably used. Moreover, the recombination center is present at the interface of the light absorption layer CIGS and the backside electrode. For this reason, if the contact area of the backside electrode and the light absorption layer is equal to and more than the area necessary for electric conduction, the generating efficiency is lowered. Therefore, in order to reduce the contact area, the electrode layer is, for example, formed to have a structure in which an insulating material and metal are placed in stripes (refer to JP-A No. 09-219530).

Examples of the layer structure of the backside electrode include a super straight structure and a substrate structure. In the case where a photoelectromotive force layer containing a semiconductive layer (light absorption layer) formed of a I-III-VI group compound semiconductor is used, it is more preferably to use the substrate structure, since the conversion efficiency thereof is high.

### [Buffer Layer]

For the buffer layer, for example, CdS, ZnS, ZnS(O,OH), ZnMgO and the like can be used. If the band gap of the light absorption layer is widened, for example, by increasing the concentration of Ga in CIGS, the conduction band thereof becomes a lot bigger than that of ZnO. Therefore, ZnMgO, a conduction band of which has large energy, is preferable for the buffer layer.

### [Transparent Conductive Layer]

After formation of the buffer layer, the transparent conductive layer for use in the solar battery of the present invention is formed preferably by coating a nanowire structure dispersion. Alternatively, a ZnO layer is formed after the formation of the buffer layer, and then the nanowire structure dispersion may be applied thereonto.

The formation method of the transparent conductive layer includes applying the dispersion onto the substrate, and drying. After application of the dispersion, annealing may be carried out by heating. Here, the heating temperature is preferably 50° C. to 300° C., more preferably 70° C. to 200° C.

The transparent conductive layer can be used for a transparent electrode of any solar battery. Moreover, the transparent conductive layer can be applied for a crystal (monocrystal, polycrystal, etc.) silicon solar battery, which does not use a transparent electrode, as an electrode for power collection. For the crystal silicon solar battery, a silver deposited electric wires, or electric wires formed of a silver paste is generally used as the powder collection electrode. However, by applying the transparent conductive layer for use in the present invention for the powder collection electrode, the crystal silicon solar battery also obtains high photoelectric conversion efficiency.

Moreover, as the solar battery of the present invention contains a transparent conductive layer having a high transmittance with respect to light of the infrared region and a low sheet resistance, it is suitably used for a solar battery having a large absorption with respect to light of the infrared region, such as an amorphous silicon solar battery of a tandem structure or the like, and a I-III-VI group compound semiconductor solar battery of Cu/In/Se (i.e., CIS type), Cu/In/Ga/Se (i.e., CIGS type), Cu/In/Ga/Se/S (i.e., CIGSS type), or the like.

### EXAMPLES

The present invention will next be described by way of examples, which should not be construed as limiting the present invention thereto.

In the following examples, the diameter of a metal nanowire, the major axis length of a metal nanowire, the variation coefficient of diameters of metal nanowires, an appropriate wire yield, and a sharpness of angles of the cross section of a metal nanowire are respectively measured in the following manners.

### <Diameter and Major Axis Length of Metal Nanowire>

Three hundred metal nanowires were observed under a transmission electron microscope (TEM) (JEM-2000FX, manufactured by JEOL Ltd.). Based on the average value obtained from the observation, the diameter and major axis length of the metal nanowires were obtained.

### <Variation Coefficient of Diameters of Metal Nanowires>

Three hundred metal nanowires were observed under a transmission electron microscope (TEM) (JEM-2000FX, manufactured by JEOL Ltd.). Based on the average value obtained from the observation, the diameter of the metal nanowires was calculated. Then, the variation coefficient was obtained by calculating the standard deviation and the average value.

### <Appropriate Wire Yield>

Each silver nanowire aqueous dispersion was filtered so as to separate silver nanowires from other particles, and the amount of Ag remained on the filter paper and the amount of Ag passed through the filter paper were respectively measured by means of ICP ATOMIC EMISSION SPECTROMETER (ICPS-8000, manufactured by Shimadzu Corporation), to thereby obtain the metal content (% by mass) of the metal nanowires (appropriate wires) each having a diameter of 50 nm or less and a length of 5 μm or more with respect to the total metal particles.

Note that, a membrane filter (FALP 02500, manufactured by Nihon Millipore K.K., pore size: 1.0 μm) was used for separating the appropriate wires when the appropriate wire yield was obtained.

### <Sharpness of Angle of Cross Section of Metal Nanowire>

The cross sectional shape of the metal nanowire was observed by applying a metal nanowire aqueous dispersion onto a substrate and observing the cross section thereof by means of a transmission electron microscope (TEM) (JEM-2000FX, manufactured by JEOL Ltd.). The periphery of the cross section and total length of each side were respectively measured on the cross sections of the three hundred metal nanowires, and the sharpness was determined as a ratio of “the periphery of the cross section” to the total length of “each side of the cross section.” When the sharpness was less than 75% or less, the angles of the cross sectional shape were considered to be round.

### Synthesis Example 1

Methanol (167 g), ethyl acetate (333 g), benzyl methacrylate (130 g), KAYARAD TC-110S (product of NIPPON KAYAKU Co., Ltd.) (30 g), 2-hydroxyethyl methacrylate (20 g), methacrylic acid (20 g), azobisisobutyronitrile (1 g) and thioglycolic acid (3 g) were mixed and stirred, followed by polymerizing at 65° C. for 6 hours. The liquid obtained after the polymerization was added to cyclohexane (3,000 g) for precipitating the formed polymer. After the supernatant had been removed through decantation, the precipitate (polymer) was dried under vacuum at 40° C. for 20 hours, to thereby obtain 138 g of polymer.

The obtained polymer was found to be a random copolymer in which the amount of benzyl methacrylate was 56 mol %, the amount of KAYARAD TC-110S was 8 mol %, the amount of 2-hydroxyethyl methacrylate was 13 mol % and the amount of methacrylic acid was 23 mol %.

The obtained polymer was found to have a weight average molecular weight (converted to polyethylene oxide) of 7,000, which is measured by gel permeation chromatography (GPC) using N,N-dimethylformamide (DMF) as a solvent.

Next, the above-obtained polymer (0.46 g), M-400 (product of TOAGOSEI CO., LTD.) (0.46 g), 4,4′-bis(diethylamino)benzophenone (0.046 g), a 25% toluene solution of 3,4,4′-tri(t-butylperoxycarbonyl)benzophenone (0.182 g) and BYK-300 (product of BYK-Chemie Japan) (0.002 g) were added to propylene glycol monomethyl ether acetate (3.30 g), followed by mixing and stirring, to thereby synthesize polymer solution (A-1).

### Synthesis Example 2

Methanol (167 g), ethyl acetate (333 g), benzyl methacrylate (100 g), KAYARAD TC-110S (product of NIPPON KAYAKU Co., Ltd.) (90 g), 2-hydroxyethyl methacrylate (5 g), methacrylic acid (5 g), azobisisobutyronitrile (1 g) and thioglycolic acid (3 g) were mixed and stirred, followed by polymerizing at 64° C. for 6 hours. The liquid obtained after the polymerization was added to cyclohexane (3,000 g) for precipitating the formed polymer. After the supernatant had been removed through decantation, the precipitate (polymer) was dried under vacuum at 40° C. for 20 hours, to thereby obtain 123 g of polymer.

The obtained polymer was found to be a random copolymer in which the amount of benzyl methacrylate was 56.6 mol %, the amount of KAYARAD TC-110S was 31.5 mol %, the amount of 2-hydroxyethyl methacrylate was 4.3 mol % and the amount of methacrylic acid was 7.6 mol %.

The obtained polymer was found to have a weight average molecular weight (converted to polyethylene oxide) of 7,100, which is measured by gel permeation chromatography (GPC) using N,N-dimethylformamide (DMF) as a solvent.

Next, the above-obtained polymer (0.46 g), M-400 (product of TOAGOSEI CO., LTD.) (0.46 g), 4,4′-bis(diethylamino)benzophenone (0.046 g), a 25% toluene solution of 3,4,4′-tri(t-butylperoxycarbonyl)benzophenone (0.182 g) and BYK-300 (product of BYK-Chemie Japan) (0.002 g) were added to propylene glycol monomethyl ether acetate (3.30 g), followed by mixing and stirring, to thereby synthesize polymer solution (A-2).

### Synthesis Example 3

Methanol (167 g), ethyl acetate (333 g), benzyl methacrylate (70 g), KAYARAD TC-1105 (product of NIPPON KAYAKU Co., Ltd.) (120 g), 2-hydroxyethyl methacrylate (5 g), methacrylic acid (5 g), azobisisobutyronitrile (1 g) and thioglycolic acid (3 g) were mixed and stirred, followed by polymerizing at 66° C. for 6 hours. The liquid obtained after the polymerization was added to cyclohexane (3,000 g) for precipitating the formed polymer. After the supernatant had been removed through decantation, the precipitate (polymer) was dried under vacuum at 40° C. for 20 hours, to thereby obtain 117 g of polymer.

The obtained polymer was found to be a random copolymer in which the amount of benzyl methacrylate was 42.4 mol %, the amount of KAYARAD TC-110S was 45.0 mol %, the amount of 2-hydroxyethyl methacrylate was 4.6 mol % and the amount of methacrylic acid was 8.1 mol %.

The obtained polymer was found to have a weight average molecular weight (converted to polyethylene oxide) of 7,400, which is measured by gel permeation chromatography (GPC) using N,N-dimethylformamide (DMF) as a solvent.

Next, the above-obtained polymer (0.46 g), M-400 (product of TOAGOSEI CO., LTD.) (0.46 g), 4,4′-bis(diethylamino)benzophenone (0.046 g), a 25% toluene solution of 3,4,4′-tri(t-butylperoxycarbonyl)benzophenone (0.182 g) and BYK-300 (product of BYK-Chemie Japan) (0.002 g) were added to propylene glycol monomethyl ether acetate (3.30 g), followed by mixing and stirring, to thereby synthesize polymer solution (A-3).

### Synthesis Example 4

Methanol (167 g), ethyl acetate (333 g), benzyl methacrylate (40 g), KAYARAD TC-110S (product of NIPPON KAYAKU Co., Ltd.) (150 g), 2-hydroxyethyl methacrylate (5 g), methacrylic acid (5 g), azobisisobutyronitrile (1 g) and thioglycolic acid (3 g) were mixed and stirred, followed by polymerizing at 63° C. for 6 hours. The liquid obtained after the polymerization was added to cyclohexane (3,000 g) for precipitating the formed polymer. After the supernatant had been removed through decantation, the precipitate (polymer) was dried under vacuum at 40° C. for 20 hours, to thereby obtain 124 g of polymer.

The obtained polymer was found to be a random copolymer in which the amount of benzyl methacrylate was 26.0 mol %, the amount of KAYARAD TC-110S was 60.4 mol %, the amount of 2-hydroxyethyl methacrylate was 4.9 mol % and the amount of methacrylic acid was 8.7 mol %.

The obtained polymer was found to have a weight average molecular weight (converted to polyethylene oxide) of 6,900, which is measured by gel permeation chromatography (GPC) using N,N-dimethylformamide (DMF) as a solvent.

Next, the above-obtained polymer (0.46 g), M-400 (product of TOAGOSEI CO., LTD.) (0.46 g), 4,4′-bis(diethylamino)benzophenone (0.046 g), a 25% toluene solution of 3,4,4′-tri(t-butylperoxycarbonyl)benzophenone (0.182 g) and BYK-300 (product of BYK-Chemie Japan) (0.002 g) were added to propylene glycol monomethyl ether acetate (3.30 g), followed by mixing and stirring, to thereby synthesize polymer solution (A-4).

### Comparative Synthesis Example 1

Methanol (142 g), ethyl acetate (283 g), benzyl methacrylate (130 g), 2-hydroxyethyl methacrylate (20 g), methacrylic acid (20 g), azobisisobutyronitrile (0.85 g) and thioglycolic acid (2.55 g) were mixed and stirred, followed by polymerizing at 65° C. for 6 hours. The liquid obtained after the polymerization was added to cyclohexane (3,000 g) for precipitating the formed polymer. After the supernatant had been removed through decantation, the precipitate (polymer) was dried under vacuum at 40° C. for 20 hours, to thereby obtain 115 g of polymer.

The obtained polymer was found to be a random copolymer in which the amount of benzyl methacrylate was 58 mol %,the amount of 2-hydroxyethyl methacrylate was 17 mol % and the amount of methacrylic acid was 25 mol %.

The obtained polymer was found to have a weight average molecular weight (converted to polyethylene oxide) of 7,200, which is measured by gel permeation chromatography (GPC) using N,N-dimethylformamide (DMF) as a solvent.

Next, the above-obtained polymer (0.46 g), M-400 (product of TOAGOSEI CO., LTD.) (0.46 g), 4,4′-bis(diethylamino)benzophenone (0.046 g), a 25% toluene solution of 3,4,4′-tri(t-butylperoxycarbonyl)benzophenone (0.182 g) and BYK-300 (product of BYK-Chemie Japan) (0.002 g) were added to propylene glycol monomethyl ether acetate (3.30 g), followed by mixing and stirring, to thereby synthesize polymer solution (A-5).

### <Preparation of Silver Nanowire Dispersion>

### —Preparation of Silver Nanowire Dispersion (1)—

The following additive liquids A, G and H were prepared in advance.

### [Additive Liquid A]

Silver nitrate powder (0.51 g) was dissolved in pure water (50 mL). Subsequently, 1N aqueous ammonia was added to the resultant solution until the solution was transparent. Then, pure water was added to the transparent solution so that the total amount was 100 mL.

### [Additive Liquid G]

Glucose powder (0.5 g) was dissolved in pure water (140 mL) to thereby prepare additive liquid G.

### [Additive Liquid H]

Hexadecyl-trimethylammonium bromide (HTAB) powder (0.5 g) was dissolved in pure water (27.5 mL) to thereby prepare additive liquid H.

Next, a silver nanowire aqueous dispersion was prepared in the following manner.

Specifically, pure water (410 mL) was added to a three-necked flask. With stirring at 20° C., additive liquid H (82.5 mL) and additive liquid G (206 mL) were added to the flask using a funnel (first step). Additive liquid A (206 mL) was added to the resultant liquid at a flow rate of 2.0 mL/min under stirring at 800 rpm (second step). Ten minutes after, additive liquid H (82.5 mL) was added thereto. The resultant mixture was increased to an internal temperature of 75° C. at a temperature increasing rate of 3° C./min, followed by heating for 5 hours under stirring at 200 rpm.

The obtained aqueous dispersion was cooled. Separately, an ultrafiltration apparatus was assembled by connecting together, via silicone tubes, an ultrafiltration module SIP1013 (product of Asahi Kasei Corporation, molecular weight cut-off: 6,000), a magnet pump and a stainless steel cup.

The silver nanowire dispersion (aqueous solution) was added to the stainless steel cup and ultrafiltrated by operating the pump. At the time when the amount of the filtrate reached 50 mL, distilled water (950 mL) was added to the stainless steel cup for washing. The washing was repeated until the conductivity reached 50 μS/cm or lower, followed by concentrating, whereby a silver nanoparticle aqueous dispersion was obtained.

The obtained silver nanoparticles were found to have a wire shape with an average minor axis length of 18 nm and an average major axis length of 38 μm.

Regarding the obtained silver nanowires (1), the variation coefficient of the diameters, the appropriate wire yield, and the degree of sharpness were found to be 22.4%, 78.7% and 44.1, respectively.

Subsequently, polyvinylpyrrolidone (K-30) and propylene glycol monomethyl ether (PGME) were added to the silver nanoparticle aqueous dispersion, followed by centrifugation. The supernatant was removed through decantation and then PGME was added to the precipitate for redispersion. This centrifugation/decantation/redispersion procedure was repeated three times in total to thereby obtain silver nanowire PGME dispersion (1). The silver content of the dispersion was found to be 2% by mass.

### —Preparation of Silver Nanowire Dispersion (2)—

Ethylene glycol (30 mL) was added to a three-necked flask, followed by heating to 160° C. Thereafter, 36 mM PVP (K-55), 3 μM acetylacetonato iron, 60 μM ethylene glycol solution of sodium chloride (18 mL), and 24 mM ethylene glycol solution of silver nitrate (18 mL) were added to the flask at a rate of 1 mL/min. The resultant mixture was heated at 160° C. for 60 min and then cooled to room temperature. Thereafter, water was added thereto, followed by centrifugation. The mixture was purified until the conductivity reached 50 μS/cm or lower, to thereby obtain a silver nanoparticle aqueous dispersion.

The obtained silver nanoparticles were found to have a wire shape with an average minor axis length of 110 nm and an average major axis length of 32 μm.

Regarding the obtained silver nanowires (2), the variation coefficient of the diameters, the appropriate wire yield, and the degree of sharpness were found to be 86.1%, 75.6% and 45.3, respectively.

After the silver nanoparticle aqueous dispersion had been centrifugated, water was removed through decantation and then propylene glycol monomethyl ether (PGME) was added to the precipitate for redispersion. This centrifugation/decantation/redispersion procedure was repeated three times in total to thereby obtain silver nanowire PGME dispersion (2). The silver content of the dispersion was found to be 2% by mass.

### Example 1

### Preparation of Photosensitive Resin Composition

Under stirring, silver nanowire PGME dispersion (1) (20 g) was gently added dropwise to polymer solution (A-1) synthesized in Synthesis Example 1, to thereby prepare a photosensitive composition.

The thus-prepared photosensitive composition of Example 1 was evaluated in terms of various properties as follows. The results are shown in Table 1.

### <(1) Formation of Patterned Transparent Conductive Film>

A glass substrate was coated through slit coating with the photosensitive composition prepared in Example 1, followed by drying for 2 min on a hot plate set to 90° C. (prebaking). The substrate was exposed through a mask to i beams (365 nm) from a high-pressure mercury lamp at 100 mJ/cm² (dose: 20 mW/cm²). The thus-exposed glass substrate was subjected to shower development for 30 sec using a developer which had been prepared by dissolving in pure water (5,000 g) sodium hydrogencarbonate (5 g) and sodium carbonate (2.5 g). The showering pressure was set to 0.04 MPa, and the time required that a stripe pattern appeared was 15 sec. The substrate was rinsed through showering of pure water and then postbaked at 200° C. for 10 min, whereby a patterned transparent conductive film was formed.

### <(2) Conductivity>

The postbaked, patterned transparent conductive film obtained in the above (1) was measured in surface resistance using Loresta-GP MCP-T600 (product of Mitsubishi Chemical Corporation).

### <(3) Resolution>

The postbaked, patterned transparent conductive film (substrate) obtained in the above (1) was observed with an optical microscope at 400-fold magnification, confirming the glass areas exposed (the mask size) in the hole pattern. The case where the hole pattern was not resoluted (i.e., the holes were not individualized) due to poor dissolvability was judged as NG (No Good).

### <(4) Transparency>

Using Heiz Gard Plus (product of Gardner Co., Ltd.), the patterned transparent conductive film obtained in the above (1) was measured in terms of the total light transmittance (%).

### <(5) Solvent Resistance>

The patterned transparent conductive film (substrate) obtained in the above (1) was immersed for 5 min in N-methyl-2-pyrrolidone of 100° C., confirming the glass areas exposed (the mask size). The case where the hole pattern was deformed due to poor solvent resistance was judged as NG (No Good).

### <(6) Alkali Resistance>

The patterned transparent conductive film (substrate) obtained in the above (1) was immersed for 10 min in a 5% aqueous potassium hydroxide solution of 60° C., confirming the glass areas exposed (the mask size). The case where the hole pattern was deformed due to poor alkali resistance was judged as NG (No Good).

### <(7) Heat Resistance>

The patterned transparent conductive film (substrate) obtained in the above (1) was heated for 1 hour in an oven set to 230° C., and measured in terms of the total light transmittance (%) similar to the above (4).

### <(8) Adhesion>

The patterned transparent conductive film (substrate) obtained in the above (1) was evaluated by the lattice pattern cutting test (cross cut test) based on the number of 1 mm×1 mm cut sections remaining after release with a piece of tape:

### Good: ≧95 (out of 100), and

### NG (No Good): <95.

### Example 2

The procedure of Example 1 was repeated, except that polymer solution (A-1) of Synthesis Example 1 was changed to polymer solution (A-2) of Synthesis Example 2, to thereby prepare and evaluate a photosensitive composition. The results are shown in Table 1.

### Example 3

The procedure of Example 1 was repeated, except that polymer solution (A-1) of Synthesis Example 1 was changed to polymer solution (A-3) of Synthesis Example 3, to thereby prepare and evaluate a photosensitive composition. The results are shown in Table 1.

### Example 4

The procedure of Example 1 was repeated, except that polymer solution (A-1) of Synthesis Example 1 was changed to polymer solution (A-4) of Synthesis Example 4, to thereby prepare and evaluate a photosensitive composition. The results are shown in Table 1.

### Example 5

The procedure of Example 1 was repeated, except that silver nanowire PGME dispersion (1) was changed to silver nanowire PGME dispersion (2), to thereby prepare and evaluate a photosensitive composition. The results are shown in Table 1.

### Example 6

The procedure of Example 1 was repeated, except that, in order to form the same photosensitive composition as that of Example 1 on the substrate, silver nanowire PGME dispersion (1) was applied onto the substrate without being mixed with polymer solution (A-1) and then polymer solution (A-1) was applied onto the dispersion, followed by drying, to thereby evaluate the formed film. The results are shown in Table 1.

### Example 7

The procedure of Example 1 was repeated, except that silver nanowire PGME dispersion (1) was changed to single wall carbon nanotubes prepared by the following method, to thereby prepare and evaluate a positive-type photosensitive composition. The results are shown in Table 1.

### —Preparation of Single Wall Carbon Nanotube—

Following the procedure of Example 1 described in Japanese Patent (JP-B) No. 3903159, a single wall carbon nanotube dispersion liquid was prepared. Specifically, single wall carbon nanotubes (synthesized referring to the literature Chemical Physics Letters, 323 (2000) pp. 580-585) and a polyoxyethylene-polyoxypropylene copolymer (dispersant) were added to an isopropyl alcohol/water (3:1) mixture (solvent). The carbon nanotube content and the dispersion content were 0.003% by mass and 0.05% by mass, respectively. Regarding the obtained carbon nanotubes, the major axis length was found to be 1 μm to 3 μm, the minor axis length 1 nm to 2 nm, and the aspect ratio 1,000 to 1,500.

### Comparative Example 1

The procedure of Example 1 was repeated, except that polymer solution (A-1) of Synthesis Example 1 was changed to polymer solution (A-5) of Comparative Synthesis Example 1, to thereby prepare and evaluate a photosensitive composition. The results are shown in Table 1.

### Comparative Example 2

The procedure of Example 1 was repeated, except that silver nanowire PGME dispersion (1) was changed to spherical silver particles prepared by the method described in The Journal of Physical Chemistry (2005) Vol. 109, p. 5497, to thereby prepare and evaluate a positive-type photosensitive composition. The results are shown in Table 1. The thus-prepared spherical silver particles were found to have a diameter of 26 nm.

### Comparative Example 3

The procedure of Example 1 was repeated, silver nanowire PGME dispersion (1) was changed to needle-shaped conductive fine particles (FS-10, ISHIHARA SHANGYO KAISHA, LTD., average major axis length: 0.5 μm, minor axis length: 0.02 μm, aspect ratio: 25), to thereby prepare and evaluate a positive-type photosensitive composition. The results are shown in Table 1.

TABLE 1

| | | | | | | Heat | |
|---|---|---|---|---|---|---|---|
| | Conductivity | | Transparency | Solvent | Alkali | resistance | |
| | (Ω/square) | Resolution | (%) | resistance | resistance | (%) | Adhesion |
| Ex. 1 | 11 | Good | 93 | Good | Good | 92 | Good |
| Ex. 2 | 12 | Good | 91 | Good | Good | 90 | Good |
| Ex. 3 | 11 | Good | 91 | Good | Good | 89 | Good |
| Ex. 4 | 14 | Good | 90 | Good | Good | 89 | Good |
| Ex. 5 | 12 | Good | 88 | Good | Good | 87 | Good |
| Ex. 6 | 14 | Good | 84 | Good | Good | 82 | Good |
| Ex. 7 | 240 | Good | 78 | Good | Good | 77 | Good |
| Comp. Ex. 1 | 130 | NG | 92 | Good | Good | 91 | NG |
| Comp. Ex. 2 | >2500 | NG | 64 | NG | Good | 61 | Good |
| Comp. Ex. 3 | 770 | NG | 74 | NG | Good | 72 | Good |

As is clear from Table 1, the photosensitive compositions of Examples 1 to 7 (the present invention) were found to be excellent in solvent resistance, alkali resistance, heat resistance, transparency, adhesion to a base, and conductivity. In addition, the transparent conductive film was formed by applying each composition onto a substrate once. In particular, the photosensitive compositions containing silver nanowires were found to exhibit remarkably advantageous effects. This fact is first disclosed in the present invention and is surprising, unexpected results.

Notably, although almost all the evaluation results in Example 6 were good, the transparency was degraded due to aggregation occurring when only silver nanowire dispersion was applied, probably because of the absence of the binder polymer.

The evaluation results in Example 7, using single wall carbon nanotubes, were generally good but inferior in transparency and conductivity to the compositions containing a silver nanowire dispersion.

In contrast, the compositions of Comparative Example 1, containing a comparative synthetic polymer and silver nanowires, were found not to exhibit excellent solvent resistance, alkali resistance, heat resistance, transparency, adhesion to a base, and conductivity which are comparable to those in Examples.

Also, in the composition of Comparative Examples 2 and 3, containing spherical silver particles or needle-shaped conductive particles instead of silver nanowires, a large amount of the silver particles or the needle-shaped conductive particles had to be applied for conduction. As a result, the transparency was considerably decreased and the resolution and the solvent resistance were judged as NG. The present invention first discloses that the compositions containing both a synthetic polymer and nanowire structures exhibit excellent solvent resistance and resolution, which is surprising, unexpected results.

### Example 8 and Comparative Example 4

### Fabrication of Display Element

In the following manner, a display element was fabricated using the photosensitive composition of the present invention.

First, a bottom gate-type TFT was formed on a glass substrate, and an insulative film of Si₃N₄ was formed so as to cover the TFT. Next, contact holes were formed in the insulative film, and wirings (height: 1.0 μm) connected through the contact holes to the TFT were formed on the insulative film.

Subsequently, in order to planarize irregularities caused as a result of formation of the wirings, a planarizing layer was formed on the insulative layer so as to embed the irregularities. Then, contact holes were formed therein to obtain planarizing film A.

Next, planarizing film A was coated through slit coating with the photosensitive composition of Example 1, followed by drying for 2 min on a hot plate set to 90° C. (prebaking). The substrate was exposed through a mask to i beams (365 nm) from a high-pressure mercury lamp at 100 mJ/cm² (dose: 20 mW/cm²). The thus-exposed glass substrate was subjected to shower development for 30 sec using a developer which had been prepared by dissolving in pure water (5,000 g) sodium hydrogencarbonate (5 g) and sodium carbonate (2.5 g). The showering pressure was set to 0.04 MPa, and the time required that a stripe pattern appeared was 15 sec. The substrate was rinsed through showering of pure water and then postbaked at 200° C. for 10 min, to thereby obtain TFT-A containing a patterned transparent conductive film (Example 8). The operation of the TFT was found to be good.

In Comparative Example 4, a patterned conductive film of ITO was formed on planarizing film A, to thereby obtain TFT-B. In Comparative Example 4, the operation of the TFT was confirmed similarly, but the TFT was found to be inferior in transmittance to that using the photosensitive composition of Example 1. In addition, uneven interference was observed in this TFT, and it was judged that it was problematic in practical use.

### Comparative Example 5 and Example 9

### Fabrication of Integrated Solar Battery

### —Fabrication of Amorphous Solar Battery (Super Straight Type)—

A fluorine-doped tin oxide film (transparent conductive film) having a thickness of 700 nm was formed on a glass substrate through MOCVD. Through plasma-enhanced chemical vapor deposition (PECVD), on the fluorine-doped thin oxide film were formed a p-type amorphous silicon film having a thickness of about 15 nm, an i-type amorphous silicon film having a thickness of about 350 nm, and an n-type amorphous silicon film having a thickness of about 30 nm. As a backside reflecting electrode, a gallium-doped zinc oxide layer having a thickness of 20 nm and a silver layer having a thickness of 200 nm were formed, to thereby fabricate a photoelectric conversion element 101 (Comparative Example 5).

A photoelectric conversion element 102 (Example 9) was produced in the same manner as in the photoelectric conversion element 101, except that, instead of forming the fluorine-doped thin oxide film, the positive-type photosensitive composition of Example 1 was applied onto the glass substrate as a transparent electrode so that the coated amount thereof became 0.1 g/m² in terms of Ag amount, followed by heating at 150° C. for 10 min.

### Comparative Example 6 and Example 10

### Fabrication of CIGS Solar Battery (Substrate Type)

On a soda-lime glass substrate, a molybdenum electrode having a film thickness of about 500 nm was formed by DC magnetron sputtering, a Cu(In_{0.6}Ga_{0.4})Se₂ thin film, which was a chalcopyrite semiconductor material film, having a film thickness of about 2.5 μm was formed thereon by vapor deposition, a cadmium sulfide thin film having a film thickness of about 50 nm was formed thereon by solution deposition, a zinc oxide thin film having a film thickness of about 50 nm was formed thereon by MOCVD, and a boron-doped zinc oxide thin film (transparent conductive layer) having a film thickness of about 100 nm was formed thereon by DC magnetron sputtering, to thereby produce a photoelectric conversion element 201 (Comparative Example 6).

A photoelectric conversion element 202 was produced in the same manner as in the photoelectric conversion element 201, except that, for forming a transparent electrode, the photosensitive composition of Example 1 was used instead of the boron-doped zinc oxide. Specifically, after formation of the cadmium sulfide thin film, the photosensitive composition of Example 1 was applied on the cadmium sulfide thin film so that the coated amount thereof became 0.1 g/m² in terms of Ag amount. The applied composition was heated at 150° C. for 10 min to thereby produce a photoelectric conversion element 202 (Example 10).

Next, each of the thus-fabricated solar batteries was evaluated in terms of conversion efficiency in the following manner. The results are shown in Table 2.

### <Evaluation of Solar Battery Properties>

Each solar battery was irradiated with simulated sunlight (AM 1.5, 100 mW/cm²) from a solar simulator, to thereby measure its solar battery properties (conversion efficiency).

TABLE 2

| | | | Conversion |
|---|---|---|---|
| | Sample | Transparent conductive layer | efficiency (%) |
| Comp. Ex. 5 | 101 | Fluorine-doped tin oxide | 6 |
| Ex. 9 | 102 | Photosensitive composition | 8 |
| | | of Ex. 1 | |
| Comp. Ex. 6 | 201 | Zinc oxide | 7 |
| Ex. 10 | 202 | Photosensitive composition | 8 |
| | | of Ex. 1 | |

As is clear from Table 2, it was found that high conversion efficiency could be attained in any type of the integrated solar batteries by using the transparent conductive layer formed form the photosensitive composition of the present invention.

Note that, the difference in the effect between Comparative Examples and the present invention is 1% to 2% in number, but this difference is considered to be important as well known in the art.

The photosensitive composition of the present invention can be suitably used in, for example, forming a patterned transparent conductive film, a display element and an integrated solar battery.

What is claimed is:

1. A photosensitive composition comprising:
a random copolymer formed through copolymerization of at least one compound represented by the following General Formula (1) and another monomer having an unsaturated bond,
a photosensitive compound, and
a nanowire structure: 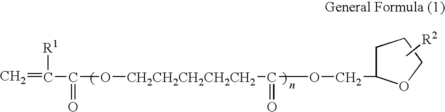
where R¹ represents a hydrogen atom or a methyl group, R² represents a C1 to C5 alkyl group and n is an integer of 0 to 5.

2. The photosensitive composition according to claim 1, wherein the amount of the at least one compound represented by General Formula (1) contained in the random copolymer is 1 mol % to 80 mol %.

3. The photosensitive composition according to claim 1, wherein the another monomer is at least one of a compound represented by the following General Formula (2), a compound represented by the following General Formula (3) and a compound represented by the following General Formula (4), and wherein, in the random copolymer, the amount of the at least one compound represented by General Formula (1) is 1 mol % to 50 mol %, the amount of the compound represented by General Formula (2) is 20 mol % to 70 mol %, the amount of the compound represented by General Formula (3) is 0 mol % to 30 mol % and the amount of the compound represented by General Formula (4) is 5 mol % to 40 mol %: 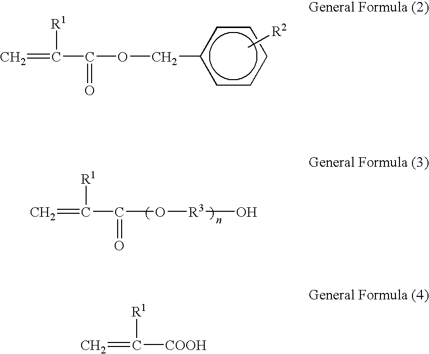
in General Formulas (2), (3) and (4), R¹ represents a hydrogen atom or a methyl group, R² represents a C1 to C5 alkyl group, R³ represents a C1 to C8 alkylene group and n is an integer of 1 to 5.

4. The photosensitive composition according to claim 1, wherein the random copolymer has a weight average molecular weight converted to polyethylene oxide of 2,000 to 30,000, which is measured by gel permeation chromatography (GPC) using N,N-dimethylformamide (DMF) as a solvent.

5. The photosensitive composition according to claim 1, wherein the nanowire structure is a metal nanowire.

6. The photosensitive composition according to claim 5, wherein the metal nanowire has a minor axis length of 50 nm or less and a major axis length of 5 μm or greater, and is contained in an amount of 50% by mass or more in terms of metal amount with respect to total metal particles.

7. A transparent conductive film comprising:
a photosensitive composition which comprises a random copolymer formed through copolymerization of at least one compound represented by the following General Formula (1) and another monomer having an unsaturated bond, a photosensitive compound, and a nanowire structure: 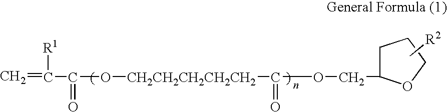
where R¹ represents a hydrogen atom or a methyl group, R² represents a C1 to C5 alkyl group and n is an integer of 0 to 5.

8. The transparent conductive film according to claim 7, wherein the transparent conductive film is used in one of a display element and an integrated solar battery.
